(19) United States
(12) Patent Application Publication
(10) Pub. No.: US 2008/0103280 A1
(43) Pub. Date: May 1, 2008

(54) Ink-jet ink and cured film obtained from same

(75) Inventors: Hiroyuki Satou, Ichihara-shi (JP); Yoshihiro Deyama, Ichihara-shi (JP); Mikio Yamahiro, Ichihara-shi (JP)

Correspondence Address: HOGAN & HARTSON LLP;IP GROUP, COLUMBIA SQUARE, 555 THIRTEENTH STREET, N.W., WASHINGTON, DC, 20004, US

(73) Assignee: CHISSO Corporation

(21) Appl. No.: 11/976,689

(22) Filed: Oct. 26, 2007

(30) Foreign Application Priority Data
Oct. 26, 2006 (JP) 290740/2006

(51) Int. Cl. C08G 77/04

(52) U.S. Cl. 528/26; 528/40

(57) ABSTRACT

The invention provides an ink-jet ink including a fluorine-containing compound (C) in the form of fluorosilsesquioxane having an organic group having 1 to 100 carbon atoms.

### CROSS REFERENCE TO RELATED APPLICATIONS

This application claims priority under 35 U.S.C. §119 to Japanese Patent Application No. JP 2006-290740, filed Oct. 26, 2006, which application is expressly incorporated herein by reference in its entirety.

### BACKGROUND OF THE INVENTION

1. Field of the Invention

The invention relates to an ink-jet ink including a fluorine-containing compound having a specific structure, and an ink-jet ink including a copolymer synthesized using a fluorine-containing compound. Moreover, the invention relates to an ink coating method using an ink-jet ink, a cured film obtained from an ink-jet ink, a cured film forming method, and an electronic circuit substrate on which a cured film is formed.

2. Related Art

The ink-jet method is widely used as a method for drawing a desired pattern on various types of substrates. In recent years in particular, it has become possible to draw high-definition patterns as a result of improvements made in ink-jet heads and ink (see, for example, WO 2004/099272).

However, depending on the combination of substrate and ink, ink droplets discharged from an ink-jet head may bleed after adhering on a substrate thereby making it difficult to draw a high-definition pattern. An example of such a case is the drawing of fine wiring on a polyimide substrate using an ink containing fine particles of metal. Although methods involving treatment of the substrate surface with a fluorine-based surfactant and the like are employed to prevent the droplets from bleeding, in the case of such methods, adhesion between the polyimide substrate and fine metal particle ink decreases resulting in the problem of increased susceptibility to separation during post-processing.

### SUMMARY OF THE INVENTION

With the foregoing in view, there is a need for a substrate surface treatment method that enables high-definition drawing by an ink-jet method, and ink-jet coating that allows surface treatment of only a desired portion is preferable for this treatment method. Thus, an ink-jet ink is required that has favorable coatability when using an ink-jet coating method, is capable of forming a coated film having favorable adhesion with a substrate, enables high-definition drawing by inhibiting bleeding of ink when drawing with a second ink-jet ink on said coated film, and has favorable adhesion between said coated film and a coated film formed with the second ink-jet ink.

It has been observed that a fluorine-containing compound having a specific structure or a copolymer synthesized using this fluorine-containing compound can be used for an ink-jet ink, thereby leading to completion of the invention on the basis of this finding.

The invention provides an ink-jet ink, ink coating method, cured film, cured film forming method and electronic circuit substrate having a cured film formed thereon as described below. Thus, the invention includes:

[1] An ink-jet ink containing a fluorine-containing compound (C) in the form of fluorosilsesquioxane having an organic group having 1 to 100 carbon atoms.

[2] An ink-jet ink containing a fluorine-containing compound (C) represented by general formula (3):

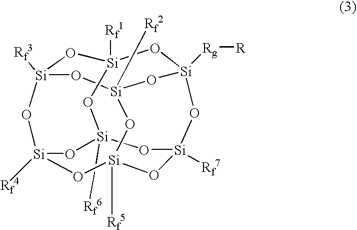

wherein, R_{g} represents a single bond or an alkylene having 1 to 20 carbon atoms in which an arbitrary methylene may be replaced by oxygen; R_{f}¹ to R_{f}⁷ respectively and independently represent a linear or branched fluoroalkyl having 1 to 20 carbon atoms in which an arbitrary methylene may be replaced by oxygen, a fluoroaryl having 6 to 20 carbon atoms in which one or more hydrogens are replaced by fluorine or —CF₃, a fluoroarylalkyl having 7 to 20 carbon atoms in which one or more hydrogens in the aryl are replaced by fluorine or —CF₃, a linear or branched alkyl having 1 to 20 carbon atoms and not containing fluorine in which an arbitrary methylene may be replaced by oxygen, an aryl having 6 to 20 carbon atoms and not containing fluorine or an arylalkyl having 7 to 20 carbon atoms and not containing fluorine, and at least one of R_{f}¹ to R_{f}⁷ is a fluoroalkyl, fluoroaryl or fluoroarylaklyl; and, R represents hydrogen or an organic group having 1 to 100 carbon atoms.

[3] The ink-jet ink according to item [2], wherein R is an organic group having 2 to 100 carbon atoms and a thermal crosslinking functional group or an organic group having 2 to 100 carbon atoms and a double bond.

[4] The ink-jet ink according to item [3], wherein the thermal crosslinking functional group is a hydroxy, oxirane, oxetane, carboxy, isocyanate, amino or acid anhydride.

[5] The ink-jet ink according to items [3] or [4], wherein the organic group having 2 to 100 carbon atoms and a double bond has an acryloyl, methacryloyl, styryl, vinyl or maleimido.

[6] The ink-jet ink according to any of items [2] to [5], wherein R_{f}¹ to R_{f}⁷ respectively and independently are a 2,2,2-trifluoroethyl, 3,3,3-trifluoropropyl, 2,2,3,3-tetrafluoropropyl, 2,2,3,3,3-pentafluoropropyl, 3,3,4,4,4-pentafluorobutyl or 3,3,4,4,5,5,6,6,6-nonafluorohexyl.

[7] The ink-jet ink according to any of items [2] to [5], R_{g} is an ethylene, propylene or butylene.

[8] An ink-jet ink including a copolymer (C′) of a fluorine-containing compound (C) in the form of fluorosilsesquioxane having an organic group having 1 to 100 carbon atoms, and other radical polymerizable monomer.

[9] An ink-jet ink including a copolymer (C′) of a fluorine-containing compound (C) represented by general formula (3):

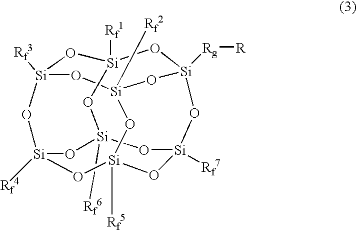

wherein, R_{g} represents a single bond or an alkylene having 1 to 20 carbon atoms in which an arbitrary methylene may be replaced by oxygen; R_{f}¹ to R_{f}⁷ respectively and independently represent a linear or branched fluoroalkyl having 1 to 20 carbon atoms in which an arbitrary methylene may be replaced by oxygen, a fluoroaryl having 6 to 20 carbon atoms in which one or more hydrogens are replaced by fluorine or —CF₃, a fluoroarylalkyl having 7 to 20 carbon atoms in which one or more hydrogens in the aryl are replaced by fluorine or —CF₃, a linear or branched alkyl having 1 to 20 carbon atoms and not containing fluorine in which an arbitrary methylene may be replaced by oxygen, an aryl having 6 to 20 carbon atoms and not containing fluorine or an arylalkyl having 7 to 20 carbon atoms and not containing fluorine, and at least one of R_{f}¹ to R_{f}⁷ is a fluoroalkyl, fluoroaryl or fluoroarylaklyl; and, R represents an organic group having 2 to 100 carbon atoms and an acryloyl, methacryloyl, styryl, vinyl or maleimido, and other radical polymerizable monomer.

[10] The ink-jet ink according to item [9], wherein R_{f}¹ to R_{f}⁷ respectively and independently are a 2,2,2-trifluoroethyl, 3,3,3-trifluoropropyl, 2,2,3,3-tetrafluoropropyl, 2,2,3,3,3-pentafluoropropyl, 3,3,4,4,4-pentafluorobutyl or 3,3,4,4,5,5,6,6,6-nonafluorohexyl.

[11] The ink-jet ink according to items [9] or [10], wherein R_{g} is an ethylene, propylene or butylene.

[12] The ink-jet ink according to any of items [8] to [11], wherein the other radical polymerizable monomer has a thermal crosslinking functional group.

[13] The ink-jet ink according to item [12], wherein the thermal crosslinking functional group of the other radical polymerizable monomer is a hydroxy, oxirane, oxetane, carboxy, isocyanate, amino or acid anhydride.

[14] The ink-jet ink according to any of items [8] to [11], wherein the other radical polymerizable monomer is at least one monomer selected from the group of glycidyl(meth)acrylate, 3,4-epoxycyclohexyl(meth)acrylate, methylglycidyl(meth)acrylate, (3-ethyl-3-oxetanyl)methyl (meth)acrylate, 2-hydroxyethyl(meth)acrylate, 2-hydroxypropyl(meth)acrylate, 4-hydroxybutyl (meth)acrylate, 4-hydroxybutyl(meth)acrylate glycidyl ether and 1,4-cyclohexane dimethanol mono(meth)acrylate.

[15] The ink-jet ink according to any of items [1] to [14] further including a compound (B) having a structural unit represented by the following general formula (2):

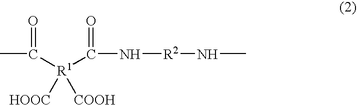

wherein, R¹ and R² respectively and independently represent an organic group having 2 to 100 carbon atoms.

[16] The ink-jet ink according to [15], wherein compound (B) is synthesized using at least a diamine (b1) and a compound (b2) having two or more acid anhydride groups.

[17] The ink-jet ink according to [16], wherein diamine (b1) is one or more groups selected from the group of 4,4′-diaminodiphenylsulfone, 3,3′-diaminodiphenylsulfone, 3,4′-diaminodiphenylsulfone, bis[4-(4-aminophenoxy)phenyl]sulfone, bis[4-(3-aminophenoxy)phenyl]sulfone, bis[3-(4-aminophenoxy)phenyl]sulfone, [4-(4-aminophenoxy)phenyl][3-(4-aminophenoxy)phenyl]sulfone, [4-(3-aminophenoxy)phenyl][3-(4-aminophenoxy)phenyl]sulfone, 4,4′-diaminodiphenyl ether, 4,4′-diaminodiphenyl methane, 3,3′-diaminodiphenyl methane, 3,3′-dimethyl-4,4′-diaminodiphenyl methane, 2,2-bis[4-(4-aminophenoxy)phenyl]propane, 2,2-bis[4-(4-aminophenoxy)phenyl]hexafluoropropane and a compound represented by formula (4):

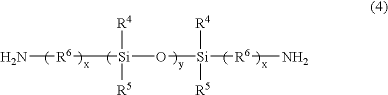

wherein, R⁴ and R⁵ independently represent an alkyl having 1 to 3 carbon atoms or phenyl, R⁶ independently represents a methylene, phenylene or alkyl-substituted phenylene, x independently represents an integer of 1 to 6, and y represents an integer of 1 to 10; and compound (b2) having two or more acid anhydride groups is one or more groups selected from the group of pyromellitic acid dianhydride, 1,2,3,4-cyclobutane tetracarboxylic acid dianhydride, 1,2,3,4-butane tetracarboxylic acid dianhydride, 1,2,4,5-cyclohexane tetracarboxylic acid dianhydride, 3,3′,4,4′-diphenylether tetracarboxylic acid dianhydride and 3,3′,4,4′-diphenylsulfone tetracarboxylic acid dianhydride.

[18] The ink-jet ink according to any of items [15] to [17] including approximately 0.1 to approximately 50% by weight of fluorine-containing compound (C) or copolymer (C′) of fluorine-containing compound (C) and other radical polymerizable monomer, and approximately 0.1 to approximately 50% by weight of compound (B).

[19] The ink-jet ink according to any of items [1] to [16] further including a compound (A) having structural units represented by the following general formulas (1) and (2):

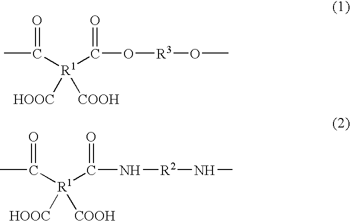

wherein, R¹, R² and R³ respectively and independently represent an organic group having 2 to 100 carbon atoms.

[20] The ink-jet ink according to item [19], wherein compound (A) is synthesized using at least a polyvalent hydroxy compound (a1), a diamine (a2) and a compound (a3) having two or more acid anhydride groups.

[21] The ink-jet ink according to item [20], wherein compound (a3) having two or more acid anhydride groups is one or more compounds selected from the group of a tetracarboxylic acid dianhydride and a copolymer of a polymerizable monomer having an acid anhydride group and other polymerizable monomer.

[22] The ink-jet ink according to item [21], wherein the copolymer of a polymerizable monomer having an acid anhydride group and other polymerizable monomer is a styrene-maleic anhydride copolymer.

[23] The ink-jet ink according to item [20], wherein the polyvalent hydroxy compound (a1) is at least one compound selected from the group of ethylene glycol, diethylene glycol, triethylene glycol, tetraethylene glycol, propylene glycol, dipropylene glycol, tripropylene glycol, tetrapropylene glycol, 1,4-butanediol, 1,5-pentanediol, 1,6-hexanediol, glycerin, trimethylolpropane, pentaerythritol and dipentaerythritol; diamine (a2) is at least one diamine selected from the group of 4′-diaminodiphenylsulfone, 3,3′-diaminodiphenylsulfone, 3,4′-diaminodiphenylsulfone, bis[4-(4-aminophenoxy)phenyl]sulfone, bis[4-(3-aminophenoxy)phenyl]sulfone, bis[3-(4-aminophenoxy)phenyl]sulfone, [4-(4-aminophenoxy)phenyl][3-(4-aminophenoxy)phenyl]sulfone, [4-(3-aminophenoxy)phenyl][3-(4-aminophenoxy)phenyl]sulfone, 4,4′-diaminodiphenylether, 4,4′-diaminodiphenylmethane, 3,3′-diaminodiphenylmethane, 3,3′-dimethyl-4,4′-diaminodiphenyl methane, 2,2-bis[4-(4-aminophenoxy)phenyl]propane, 2,2-bis[4-(4-aminophenoxy)phenyl]hexafluoropropane and a compound represented by formula (4):

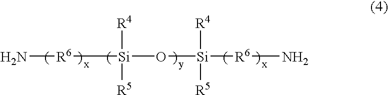

wherein, R⁴ and R⁵ independently represent an alkyl having 1 to 3 carbon atoms or phenyl, R⁶ independently represent a methylene, phenylene or alkyl-substituted phenylene, x independently represents an integer of 1 to 6, and y represents an integer of 1 to 10; and, compound (a3) having two or more acid anhydride groups is one or more compounds selected from the group of styrene-maleic anhydride copolymer, pyromellitic acid dianhydride, 1,2,3,4-cyclobutane tetracarboxylic acid dianhydride, 1,2,3,4-butane tetracarboxylic acid dianhydride, 1,2,4,5-cyclohexane tetracarboxylic acid dianhydride, 3,3′,4,4′-diphenylether tetracarboxylic acid dianhydride and 3,3′,4,4′-diphenylsulfone tetracarboxylic acid dianhydride.

[24] The ink-jet ink according to item [20], wherein polyvalent hydroxy compound (a1) is one or more compounds selected from the group of 1,4-butanediol, 1,5-pentanediol and 1,6-hexanediol; diamine (a2) is one or more diamines selected from the group of 3,3′-diaminodiphenylsulfone, 4,4′-diaminodiphenyl ether, 4,4′-diaminodiphenylmethane and a compound represented by formula (4):

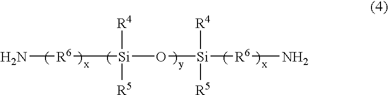

wherein, R⁴ and R⁵ independently represent an alkyl having 1 to 3 carbon atoms or phenyl, R⁶ independently represent a methylene, phenylene or alkyl-substituted phenylene, x independently represents an integer of 1 to 6, and y represents an integer of 1 to 10; and, compound (a3) having two or more acid anhydride groups is one or more compounds selected from the group of pyromellitic acid, styrene-maleic anhydride copolymer, 3,3′,4,4′-diphenylether tetracarboxylic acid dianhydride, 3,3′,4,4′-diphenylsulfone tetracarboxylic acid dianhydride and butane tetracarboxylic acid dianhydride.

[25] The ink-jet ink according to any of items [1] to [24] further including an epoxy resin (D).

[26] The ink-jet ink according to item [25], wherein epoxy resin (D) is one or more resins selected from the group of compounds represented by the following formulas (5) to (8):

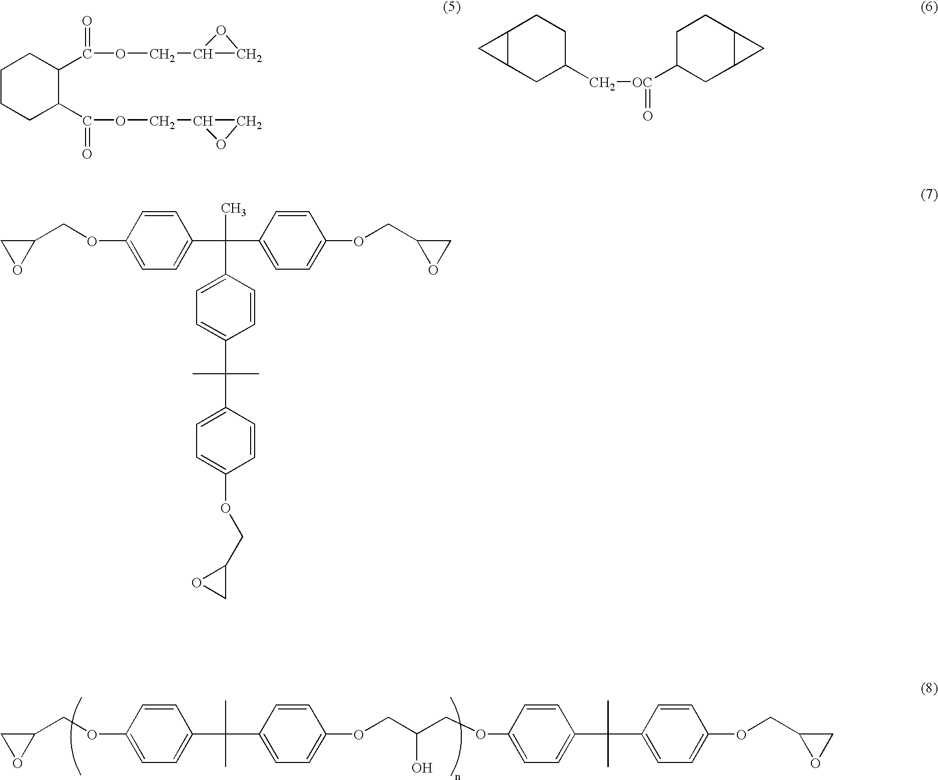

wherein, n represents an integer of 0 to 10.

[27] The ink-jet ink according to any of items [1] to [26], further including an acid generator (E).

[28] A cured film obtained through a step of forming a coated film by coating the ink-jet ink according to any of items [1] to [27] by an ink-jet coating method.

[29] An ink coating method comprising: a step of forming a coated film by coating the ink-jet ink according to any of items [1] to [27] by an ink-jet coating method followed by drying; and a step of forming a cured film by heat-treating the coated film.

[30] A cured film forming method comprising forming a cured film using the ink coating method according to item [29].

[31] An electronic circuit substrate on which a cured film is formed on a substrate using the cured film forming method according to item [30].

[32] An electronic component having the electronic circuit substrate according to item [31].

[33] An electronic circuit board and a display element having the cured film of item [28].

The “alkyl” in the “alkyl-substituted phenylene” of R⁶ in the above-mentioned formula (4) is preferably an alkyl having 2 to 10 carbon atoms, and more preferably an alkyl having 2 to 6 carbon atoms. Examples of alkyls include, but are not limited to, ethyl, propyl, isopropyl, butyl, s-butyl, t-butyl, pentyl, hexyl and dodecanyl.

Furthermore, “(meth)acryl” as used herein indicates the generic term for acryl and methacryl.

An ink-jet ink in a preferable aspect of the invention has, for example, preferable coatability attributable to an ink-jet coating method.

In addition, when an ink-jet ink in a preferable aspect of the invention is used, since bleeding of ink is inhibited and control of contact angle is superior when coating onto a substrate using, for example, an ink-jet coating method, high-definition drawing is possible using an ink-jet coating method. In addition, when an ink-jet ink in a preferable aspect of the invention is used, adhesion between a substrate on which an ink has been coated using, for example, an ink-jet coating method and the resulting coated film is increased. When an ink-jet ink in an even more preferable aspect is used, high-definition drawing is possible using, for example, an ink-jet coating method, and adhesion between the substrate and resulting coated film is increased.

### DETAILED DESCRIPTION OF THE INVENTION

1. Ink-jet Ink of the Invention

A first aspect of the ink-jet ink of the invention is an ink-jet ink including a fluorine-containing compound (C) represented by the above-mentioned formula (3). In addition, a second aspect of the ink-jet ink of the invention is an ink-jet ink including a copolymer (C′) of fluorine-containing compound (C) and other radical polymerizable monomer.

1.1 Fluorine-Containing Compound (C)

Fluorine-containing compound (C) contained in the ink-jet ink of the invention is a fluorosilsesquioxane having an organic group having 1 to 100 carbon atoms, and is preferably a compound represented by the above-mentioned formula (3).

In formula (3), R_{g} represents a single bond or an alkylene having 1 to 20 carbon atoms in which an arbitrary methylene may be replaced by oxygen.

In formula (3), R_{g} preferably represents an alkylene having 1 to 10 carbon atoms (in which an arbitrary methylene may be replaced by oxygen, or an arbitrary hydrogen may be replaced by fluorine). R_{g} is more preferably ethylene, propylene or butylene, and particularly preferably propylene.

In formula (3), R_{f}¹ to R_{f}⁷ respectively and independently represent a linear or branched fluoroalkyl having 1 to 20 carbon atoms in which an arbitrary methylene may be replaced by oxygen, a fluoroaryl having 6 to 20 carbon atoms in which one or more hydrogens are replaced by fluorine or —CF₃, a fluoroarylalkyl having 7 to 20 carbon atoms in which one or more hydrogens in the aryl are replaced by fluorine or —CF₃, a linear or branched alkyl having 1 to 20 carbon atoms and not containing fluorine in which an arbitrary methylene may be replaced by oxygen, an aryl having 6 to 20 carbon atoms and not containing fluorine or an arylalkyl having 7 to 20 carbon atoms and not containing fluorine, and at least one of R_{f}¹ to R_{f}⁷ is a fluoroalkyl, fluoroaryl or fluoroarylaklyl.

In formula (3), R_{f}¹ to R_{f}⁷ respectively and independently preferably represent a fluoroalkyl such as a trifluoromethyl, 2,2,2-trifluoroethyl, 3,3,3-trifluoropropyl, 2,2,3,3-tetrafluoropropyl, 2,2,3,3,3-pentafluoropropyl, 2,2,2-trifluoro-1-trifluoromethylethyl, 2,2,3,4,4,4-hexafluorobutyl, 2,2,3,3,4,4,5,5-octafluoropentyl, 2,2,2-trifluoroethyl, 2,2,3,3-tetrafluoropropyl, 2,2,3,3,3-pentafluoropropyl, 2,2,3,3,4,4,5,5-octafluoropentyl, 3,3,3-trifluoropropyl, nonafluoro-1,1,2,2-tetrahydrohexyl, tridecafluoro-1,1,2,2-tetrahydrooctyl, heptadecafluoro-1,1,2,2-tetrahydrodecyl, perfluoro-1H,1H,2H,2H-dodecyl, perfluoro-1H,1H,2H,2H-tetradecyl or 3,3,4,4,5,5,6,6,6-nonafluorohexyl, or a hydrocarbon group such as a phenyl, propyl, butyl, methylphenyl, ethylphenyl or propylphenyl, provided that at least one of R_{f}¹ to R_{f}⁷ is selected from fluoroalkyls.

In formula (3), if R_{f}¹ to R_{f}⁷ respectively and independently represent a 2,2,2-trifluoroethyl, 3,3,3-trifluoropropyl, 2,2,3,3-tetrafluoropropyl, 2,2,3,3,3-pentafluoropropyl, 3,3,4,4,4-pentafluorobutyl or 3,3,4,4,5,5,6,6,6-nonafluorohexyl, it becomes easier to further increase the contact angle of droplets discharged from an ink-jet onto the resulting coated film, thereby preferably enabling high-definition drawing.

Moreover, R_{f}¹ to R_{f}⁷ are preferably all 2,2,2-trifluoroethyl, 3,3,3-trifluoropropyl, 2,2,3,3-tetrafluoropropyl or 3,3,4,4,5,5,6,6,6-nonafluorohexyl, and R_{f}¹ to R_{f}⁷ are more preferably all 3,3,3-trifluoropropyl or 3,3,4,4,5,5,6,6,6-nonafluorohexyl.

In formula (3), R represents a hydrogen or an organic group having 1 to 100 carbon atoms.

In formula (3), R preferably represents an organic group having 1 to 100 carbon atoms and a thermal crosslinking functional group or a double bond. If the thermally crosslinking function group is a hydroxy, oxirane, oxetane, carboxy, isocyanate, amino or acid anhydride, adhesion of the resulting ink-jet ink to the substrate is increased, thereby making this preferable. In addition, if the organic group having 1 to 100 carbon atoms and a double bond has an acryloyl, methacryloyl, styryl, vinyl or maleimido, adhesion of the resulting ink-jet ink to the substrate is increased, thereby making this preferable.

In the invention, although there are no particular limitations on the concentration of fluorine-containing compound (C) in the ink-jet ink of the invention, approximately 0.1 to approximately 50% by weight is preferable. Moreover, if said concentration is approximately 0.5 to approximately 20% by weight, it becomes easier to coat with an ink-jet from the viewpoint of ink viscosity, thereby making this preferable.

Furthermore, fluorine-containing compound (C) may be used in a single type of compound or may be used in a mixture of two or more types of compounds.

1.2 Copolymer (C′) of Fluorine-Containing Compound (C) and Other Radical

Polymerizable Monomer

A copolymer contained in an ink-jet ink of a second aspect of the invention is a copolymer (C′) of fluorine-containing compound (C) represented by the above-mentioned formula (3) and other radical polymerizable monomer.

Although R in formula (3) representing fluorine-containing compound (C) used in the ink-jet ink of a second aspect of the invention is an organic group having 2 to 100 carbon atoms and acryloyl, methacryloyl, styryl, vinyl or maleimido, if R is an organic group having 2 to 100 carbon atoms and an acryloyl or methacryloyl in particular, the copolymer can be synthesized easily, thereby making this preferable. Furthermore, in formula (3) representing fluorine-containing compound (C) used to synthesize copolymer (C′), R_{f}¹ to R_{f}⁷ and R_{g} are the same as in fluorine-containing compound (C) used in the ink-jet ink of the first aspect.

There are no particular limitations on the other radical polymerizable monomer able to be used to synthesize copolymer (C′) provided it has a radical polymerizable functional group.

The other radical polymerizable monomer preferably contains a crosslinking functional group. Examples of other radical polymerizable monomers containing a crosslinking function group include hydroxyalkyl(meth)acrylates such as 2-hydroxyethyl(meth)acrylate, 2-hydroxypropyl(meth)acrylate, 4-hydroxybutyl(meth)acrylate or 1,4-cyclohexane dimethanol mono(meth)acrylate; (meth)acrylic acid derivatives such as glycidyl(meth)acrylate, 3,4-epoxycyclohexyl(meth)acrylate, methylglycidyl(meth)acrylate, 4-hydroxybutyl(meth)acrylate glycidyl ether, (3-ethyl-3-oxetanyl)methyl(meth)acrylate, 2-(meth)acryloyloxyethyl isocyanate, γ-(methacryloyloxypropyl)trimethoxysilane or 2-aminoethy(meth)acrylate; and styrene derivatives such as glycidylvinyl benzyl ether. Among these, preferable examples include glycidyl(meth)acrylate, 3,4-epoxycyclohexyl(meth)acrylate, methylglycidyl(meth)acrylate, (3-ethyl-3-oxetanyl)methyl(meth)acrylate, 2-hydroxyethyl(meth)acrylate, 2-hydroxypropyl(meth)acrylate, 4-hydroxybutyl(meth)acrylate, 4-hydroxybutyl(meth)acrylate glycidyl ether and 1,4-cyclohexane dimethanol mono(meth)acrylate. If these monomers are used as the other radical polymerizable monomer, adhesion of the resulting ink-jet ink to the substrate is increased, thereby making this preferable.

Copolymer (C′) is preferably mixed so that the weight ratio of fluorine-containing compound (C) represented by the above-mentioned formula (3) having a prescribed structure and other radical polymerizable monomer is approximately 0.5:99.5 to approximately 50:50.

Although a high molecular weight is preferable for the chemical resistance of the ink-jet ink of the invention, a low molecular weight is preferable for solubility in solvent. Thus, the weight average molecular weight of copolymer (C′) is preferably approximately 2,000 to approximately 1,000,000 and more preferably approximately 3,000 to approximately 100,000. In addition, the molecular weight distribution Mw/Mn of the copolymer is normally preferably approximately 1.2 to approximately 20.

Although there are no particular limitations on the concentration of copolymer (C′), approximately 0.1 to approximately 50% by weight is preferable. Moreover, if the concentration is approximately 0.5 to approximately 20% by weight, it becomes easier to coat with an ink-jet from the viewpoint of ink viscosity, thereby making this preferable.

In addition, there are no particular limitations on the arrangement form of copolymer (C′), and may be in the form of, for example, an ordered copolymer such as a block copolymer or a random copolymer.

Copolymer (C′) can be produced by addition polymerization by mixing the above-mentioned fluorine-containing compound (C) having a prescribed structure with another radical polymerizable monomer.

Addition polymerization can be carried out using a polymerization initiator. Examples of polymerization initiators include azo compounds such as 2,2′-azobisisobutyronitrile, 2,2′-azobis(2,4-dimethylvaleronitrile), 2,2′-azobis(2-butyronitrile), dimethyl-2,2′-azobisisobutyrate and 1,1′-azobis(cyclohexane-1-carbonitrile); peroxides such as benzoyl peroxide, lauryl peroxide, octanoyl peroxide, acetyl peroxide, di-t-butyl peroxide, t-butyl cumyl peroxide, dicumyl peroxide, t-butyl peroxyacetate, t-butyl peroxybenzoate and t-butyl peroxyneodecanoate; and dithiocarbamates such as tetraethylthiuram disulfide. Other examples of polymerization initiators include photopolymerization initiators and living radical polymerization initiators.

Although there are no particular limitations on the amount of polymerization initiator used in addition polymerization, the amount used is preferably approximately 0.1 to approximately 10% by weight based on the total monomer weight.

A chain transfer agent may also be used in the above-mentioned addition polymerization. The use of a chain transfer agent enables suitable control of molecular weight. Examples of chain transfer agents include mercaptans such as thio-β-naphthol, thiophenol, n-butylmercaptan, ethylthioglycolate, mercaptoethanol, mercaptoacetic acid, isopropyl mercaptan, t-butyl mercaptan, dodecanethiol, thiomalic acid, pentaerythritol tetra(3-mercaptopropionate) and pentaerythritol tetra(3-mercaptoacetate), and disulfides such as diphenyl disulfide, diethyl dithioglycolate and diethyl disulfide. Other examples of chain transfer agents include toluene, methyl isobutyrate, carbon tetrachloride, isopropyl benzene, diethyl ketone, chloroform, ethyl benzene, butyl chloride, sec-butyl alcohol, methyl ethyl ketone, methyl isobutyl ketone, propylene chloride, methyl chloroform, t-butyl benzene, n-butyl alcohol, isobutyl alcohol, acetic acid, ethyl acetate, acetone, dioxane, ethane tetrachloride, chlorobenzene, methyl cyclohexane, b-butyl alcohol and benzene.

Among these examples of chain transfer agents, mercaptan chain transfer agents are preferable, while mercaptoacetic acid is particularly preferable since it results in uniform molecular weight distribution.

A chain transfer agent can be used alone or two or more types can be used as a mixture.

Copolymer (C′) is produced using an ordinary method for polymerizing addition polymers, examples of which include solution polymerization, emulsification polymerization, suspension polymerization, bulk polymerization, bulk suspension polymerization and polymerization using supercritical CO₂.

In the case of polymerizing by solution polymerization, for example, fluorine-containing compound (C), another radical polymerizable monomer, a polymerization initiator and a chain transfer agent are dissolved in a suitable solvent followed by heating and/or irradiating with light to carry out an addition polymerization reaction and obtain said copolymer.

Examples of solvents used in a polymerization reaction to obtain copolymer (C′) include hydrocarbon-based solvents (such as benzene or toluene), ether-based solvents (such as diethyl ether, tetrahydrofuran, diphenyl ether, anisole or dimethoxybenzene), halogenated hydrocarbon-based solvents (such as methylene chloride, chloroform or chlorobenzene), ketone-based solvents (such as acetone, methyl ethyl ketone or methyl isobutyl ketone), alcohol-based solvents (such as methanol, ethanol, propanol, isopropanol, n-butyl alcohol or tert-butyl alcohol), nitrile-based solvents (such as acetonitrile, propionitrile or benzonitrile), ester-based solvents (such as ethyl acetate or butyl acetate), carbonate-based solvents (such as ethylene carbonate or propylene carbonate), amide-based solvents (such as N,N-dimethylformamide or N,N-dimethylacetoamide), hydrochlorofluorocarbon-based solvents (such as HCFC-141b or HCFC-225), hydrofluorocarbon-based (HFCs)-based solvents (such as HFCs having 2 to 4, 5 or 6 or more carbon atoms), perfluorocarbon-based solvents (such as perfluoropentane or perfluorohexane), alicyclic hydrofluorocarbon-based solvents (such as fluorocyclopentane or fluorocyclobutane), oxygen-containing fluorine-based solvents (such as fluoroether, fluoropolyether, fluoroketone or fluoroalcohol), aromatic-based fluorine solvents (such as α,α,α-trifluorotoluene or hexafluorobenzene) and water.

These solvents may be used alone or two or more types may be used in combination.

The amount of solvent used may be an amount that results in a monomer concentration of approximately 10 to approximately 50% by weight.

Although there are no particular limitations on the polymerization reaction temperature, approximately 0 to approximately 200° C. is preferable and approximately 40 to approximately 150° C. is more preferable. In addition, the polymerization reaction can be carried out under reduced pressure, normal pressure or increased pressure according to the type of monomer and type of solvent.

In order to obtain a polymer for which the molecular weight has been suitably controlled by inhibiting decreases in the polymerization rate caused by deactivation of generated radicals due to contact with oxygen, the polymerization reaction is preferably carried out in an inert gas atmosphere such as nitrogen or argon. In addition, the polymerization reaction may also be carried out in a polymerization system in which dissolved oxygen has been removed under reduced pressure. After having removed the dissolved oxygen under reduced pressure, the polymerization reaction may subsequently carried out while still under reduced pressure.

A polymer obtained in solution may be purified or isolated in accordance with ordinary methods.

Furthermore, fluorine-containing compound (C) used to obtain copolymer (C′) may be used in a single type of compound alone or may be used in a mixture of two or more types of compounds. Similarly, the other radical polymerizable monomer used to obtain copolymer (C′) may be used in a single type of compound alone or may be used in a mixture of two or more types of compounds.

2. Compounds Optionally Contained in Ink-jet Ink of the Invention

Although there are no particular limitations on the ink-jet ink of the invention provided it includes fluorine-containing compound (C) or copolymer (C′), it may also optionally include a compound (B) having the structural unit represented by the above-mentioned formula (2), a compound (A) having the structural unit represented by the above-mentioned formulas (1) and (2), an epoxy resin (D) and an acid generator (E).

2.1 Compound (B) (Polyamide Acid)

The ink-jet ink of the invention may further include a compound (B) having the structural unit represented by formula (2). If compound (B) is included in the ink-jet ink, adhesion of the ink to a substrate, and particularly a polyimide substrate, is increased, thereby making this preferable.

(1) Structural Unit Contained in Compound (B)

In the above-mentioned formula (2), although R¹ is an organic group having 2 to 100 carbon atoms, this R¹ is a residue of a compound having two or more acid anhydride groups, and preferably a tetracarboxylic acid dianhydride residue or styrene-maleic anhydride copolymer residue. In addition, in the formula (2), although R² is an organic group having 2 to 100 carbon atoms, this R² is a diamine residue.

Although a high molecular weight is preferable for the chemical resistance of the heat-curable composition of the invention, since a low molecular weight is preferable for solubility in solvent, the weight average molecular weight of compound (B) is preferably approximately 1,000 to approximately 500,000 and more preferably approximately 2,000 to approximately 200,000.

Although there are no particular limitations on the concentration of compound (B) in the heat-curable composition of the invention, approximately 0.1 to approximately 50% by weight is preferable, and if the concentration is approximately 0.5 to approximately 20% by weight, coating with an ink-jet becomes easier from the viewpoint of ink viscosity, thereby making this preferable.

(2) Production Process of Compound (B)

Compound (B) included in the ink-jet ink of the invention is obtained by, for example, reacting at least a diamine (b1) and a compound (b2) having two or more acid anhydride groups.

(3) Diamine (b1)

There are no particular limitations on diamine (b1) able to be used to synthesize compound (B) in the invention provided it has two amino groups, and a typical example thereof is a compound represented by the general formula NH₂—R—NH₂ (wherein, R represents an organic group having 2 to 100 carbon atoms). Specific examples of compounds represented by this general formula include compounds represented by the following general formulas (II) to (VIII):

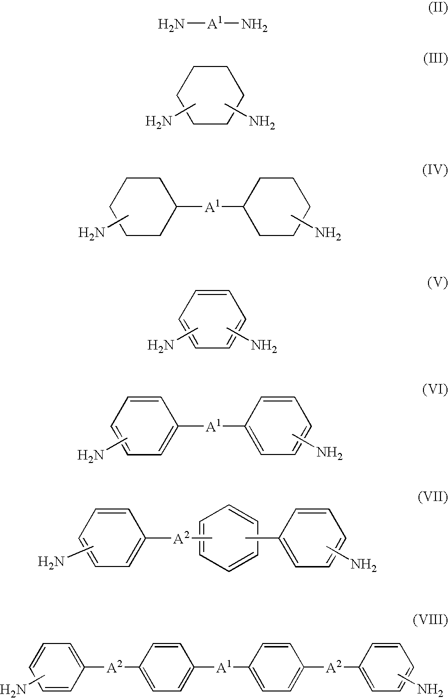

wherein, in formulas (II) and (IV; A¹ is —(CH₂)ₘ— where m is an integer of 1 to 6, and in formulas (VI) to (VIII), A¹ is a single bond, —O—, —S—, —S—S—, —SO₂—, —CO—, —CONH—, —NHCO—, —C(CH₃)₂—, —C(CF₃)₂—, —(CH₂)ₘ—, —O—(CH₂)ₘ—O— or —S—(CH₂)ₘ—S—, wherein m is an integer of 1 to 6, A² is a single bond, —O—, —S—, —CO—, —C(CH₃)₂—, —C(CF₃)₂— or an alkylene having 1 to 3 carbon atoms, and hydrogens bonded to a cyclohexane ring or benzene ring may be replaced by —F or —CH₃).

Examples of diamines represented by general formula (II) include the diamines represented by formulas (II-1) to (II-3).

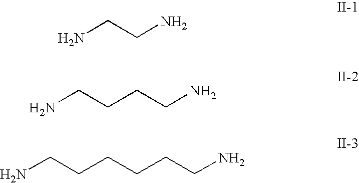

Examples of diamines represented by general formula (III) include the diamines represented by formulas (III-1) and (III-2).

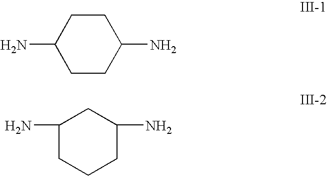

Examples of diamines represented by general formula (IV) include the diamines represented by formulas (IV-1) to (IV-3).

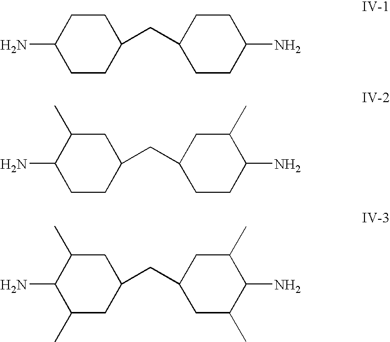

Examples of diamines represented by general formula (V) include the diamines represented by formulas (V-1) to (V-5).

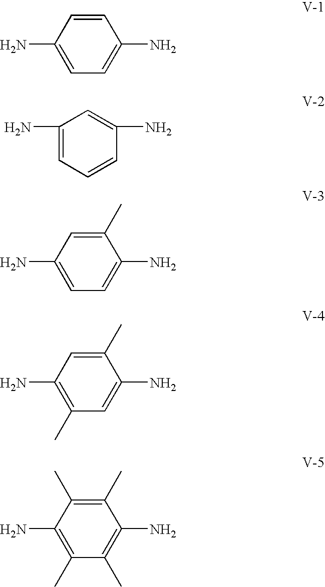

Examples of diamines represented by general formula (VI) include the diamines represented by formulas (VI-1) to (VI-30).

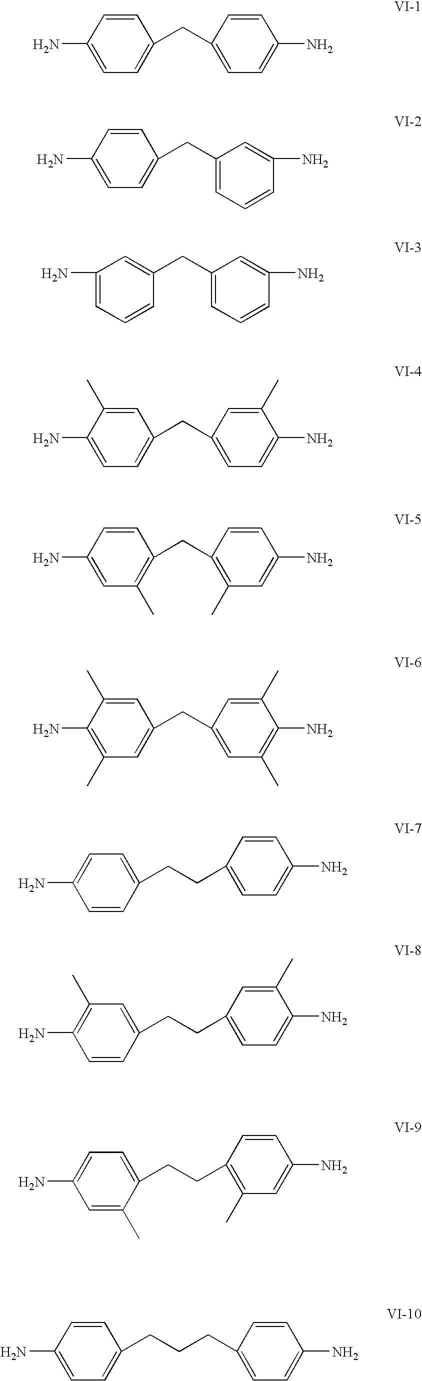

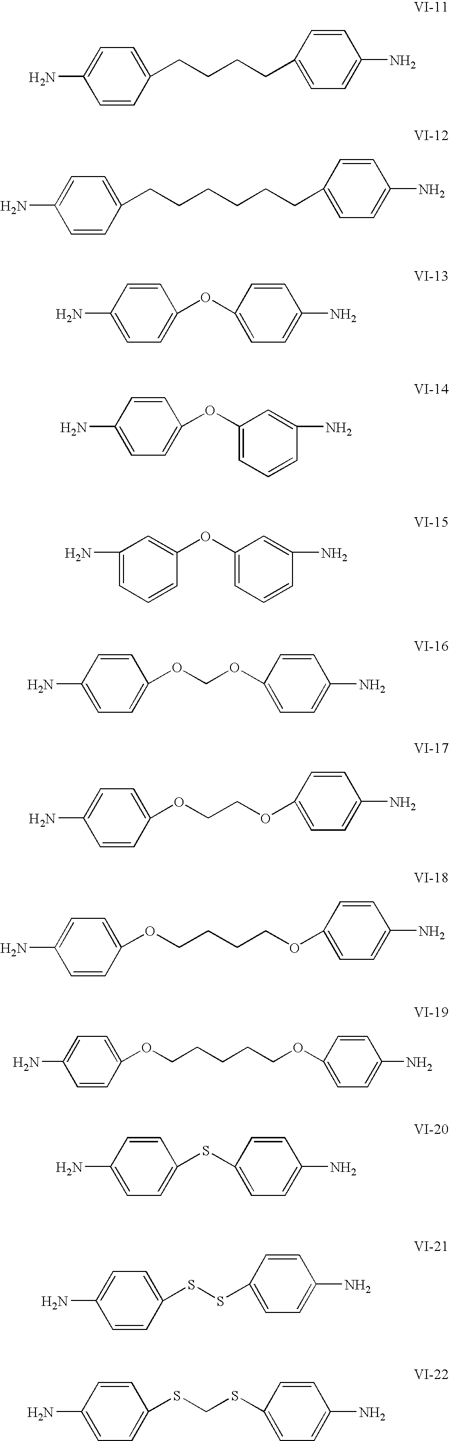

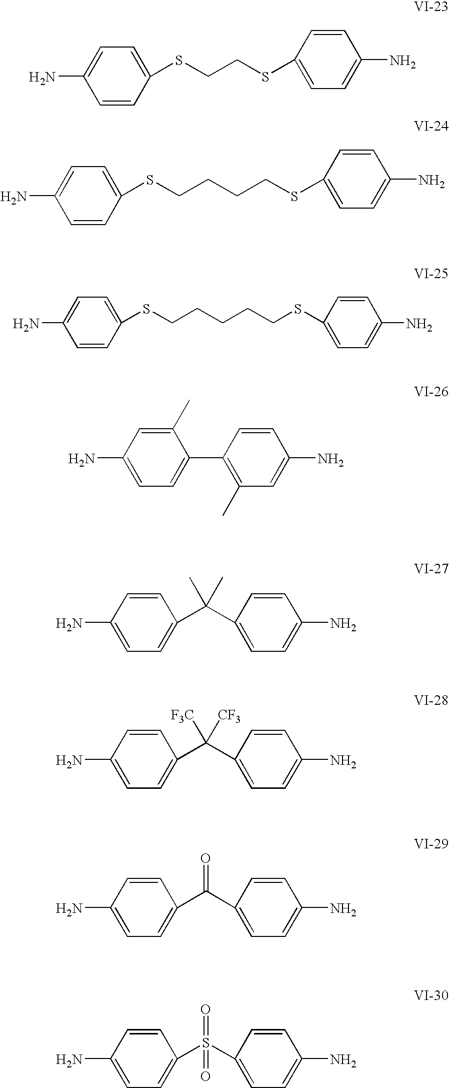

Examples of diamines represented by general formula (VII) include the diamines represented by formulas (VII-1) to (VII-6).

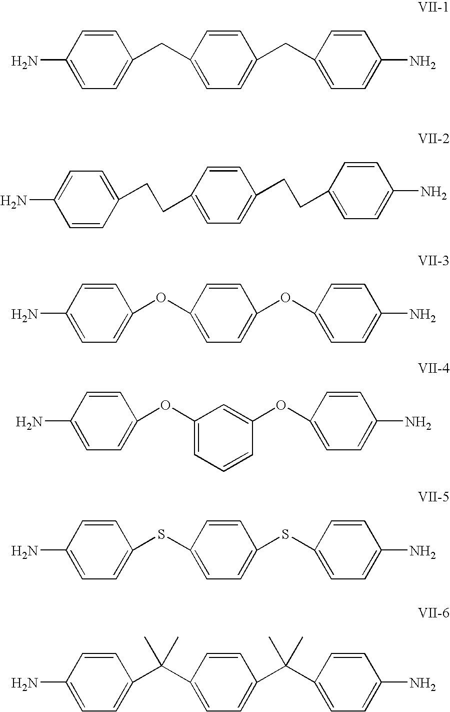

Examples of diamines represented by general formula (VIII) include the diamines represented by formulas (VIII-1) to (VIII-11).

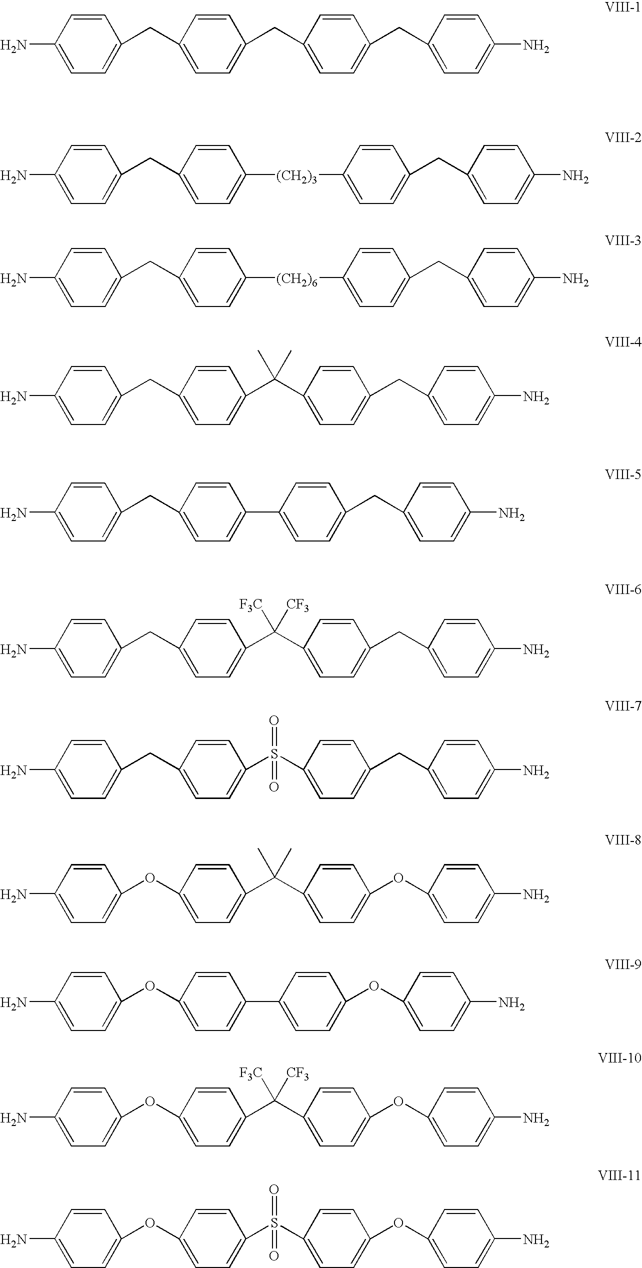

Preferable examples of the above-mentioned specific examples of diamine (b1) represented by general formulas (II) to (VIII) include the diamines represented by formulas (V-1) to (V-5), formulas (VI-1) to (VI-12), formula (VI-26), formula (VI-27), formula (VII-1), formula (VII-2), formula (VII-6) and formulas (VIII-1) to (VIII-5), while more preferable examples include diamines represented by formula (V-6), formula (V-7) and formulas (VI-1) to (VI-12).

In the invention, additional examples of diamine (b1) used to synthesize compound (B) include diamines represented by general formula (IX):

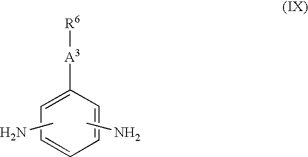

wherein formula (IX), A³ represents a single bond, —O—, —COO—, —OCO—, —CO—, —CONH— or —(CH₂)ₘ— (wherein, m represents an integer of 1 to 6); R⁶ represents an organic group having 1 to 30 carbon atoms, the end of said organic group may be an —H or halogen, and preferably said organic group is a group having a steroid backbone, group represented by the following formula (X), or when the positional relationship of the two amino groups bonded to the benzene ring is the para position, an alkyl group having 1 to 20 carbon atoms or when said positional relationship is the meta position, an alkyl having 1 to 10 carbon atoms or phenyl group; an arbitrary —CH₂— in said alkyl may be replaced by —CF₂—, —CHF—, —O—, —CH═CH— or —C≡C—, and —CH₃ may be replaced by —CH₂F, —CHF₂ or —CF₃; and a hydrogen bonded to a ring-forming carbon of said phenyl may be replaced by —F, —CH₃, —OCH₃, —OCH₂F, —OCHF₂ or —OCF₃;

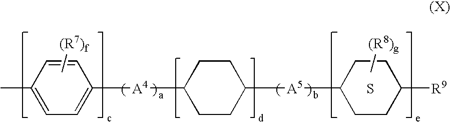

wherein formula (X), A⁴ and A⁵ respectively and independently represent a single bond, —O—, —COO—, —OCO—, —CONH—, —CH═CH— or an alkylene having 1 to 12 carbon atoms; R⁷ and R⁸ respectively and independently represent —F or —CH₃; ring S represents 1,4-phenylene, 1,4-cyclohexylene, 1,3-dioxane-2,5-diyl, pyrimidine-2,5-diyl, pyridine-2,5-diyl, naphthalene-1,5-diyl, naphthalene-2,7-diyl or anthracene-9,10-diyl; R⁹ represents —H, —F, alkyl having 1 to 12 carbon atoms, fluorine-substituted alkyl having 1 to 12 carbon atoms, alkoxy having 1 to 12 carbon atoms, —CN, —OCH₂F, —OCHF₂ or —OCF₃; a and b respectively and independently represent an integer of 0 to 4; c, d and e respectively and independently represent an integer of 0 to 3, and when e is 2 or 3, a plurality of rings S may be the same or different groups; f and g respectively and independently represent an integer of 0 to 2; and c+d+e≧1.

In general formula (IX), although two amino groups are bonded to carbons of a phenyl ring, the bonding positional relationship of the two amino groups is preferably the meta position or the para position. Moreover, the two amino groups are preferably bonded at positions 3 and 5 or 2 and 5, respectively, when the bonding position of “R⁶-A³-” is position 1.

Examples of diamines represented by general formula (IX) include the diamines represented by the following formulas (IX-1) to (IX-11).

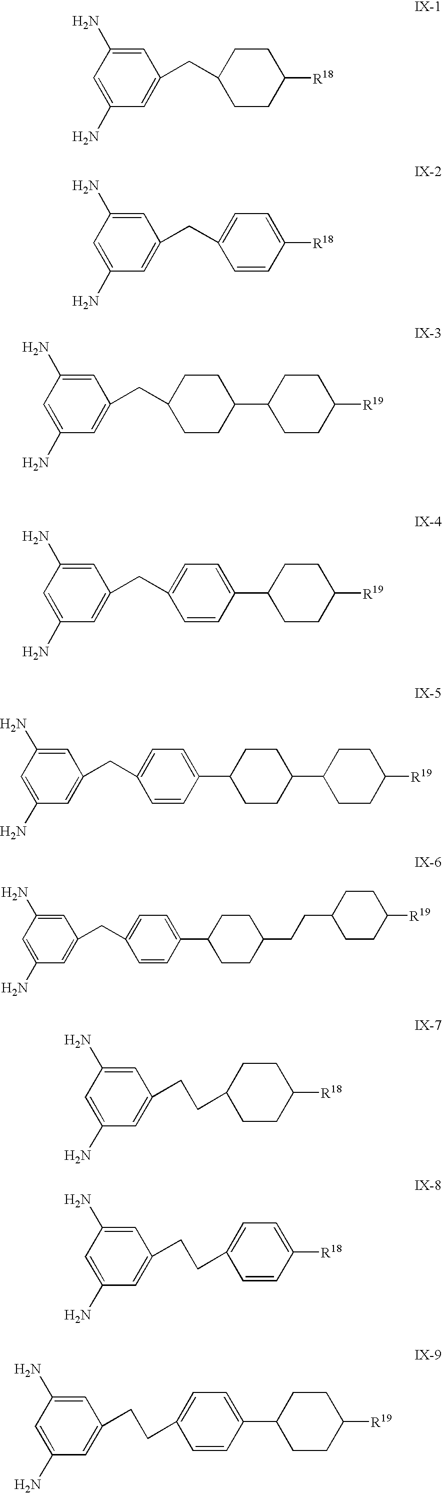

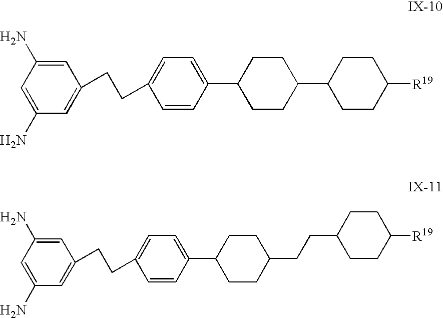

In formulas (IX-1), (IX-2), (IX-7) and (IX-8) above, R¹⁸ represents an alkyl having 3 to 12 carbon atoms or an alkoxy having 3 to 12 carbon atoms, an alkyl having 5 to 12 carbon atoms or an alkoxy having 5 to 12 carbon atoms is preferable. In addition, in formulas (IX-3) to (IX-6) and formulas (IX-9) to (IX-11), R¹⁹ represents an alkyl having 1 to 10 carbon atoms or an alkoxy having 1 to 10 carbon atoms, an alkyl having 3 to 10 carbon atoms or an alkoxy having 3 to 10 carbon atoms is preferable.

Additional examples of diamines represented by general formula (IX) include the diamines represented by the following formulas (IX-12) to (IX-17).

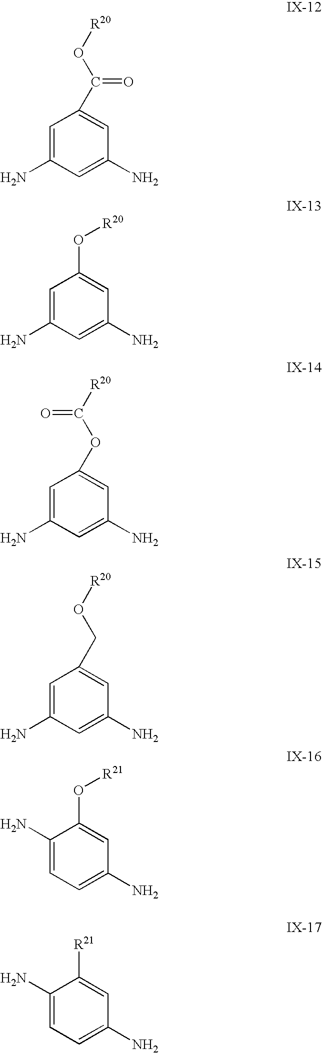

In formulas (IX-12) to (IX-15) above, R²⁰ represents an alkyl having 4 to 16 carbon atoms and preferably an alkyl having 6 to 16 carbon atoms. In formulas (IX-16) and (IX-17), R²¹ represents an alkyl having 6 to 20 carbon atoms and preferably an alkyl having 8 to 20 carbon atoms.

Additional examples of diamines represented by general formula (IX) include the diamines represented by the following formulas (IX-18) to (IX-38).

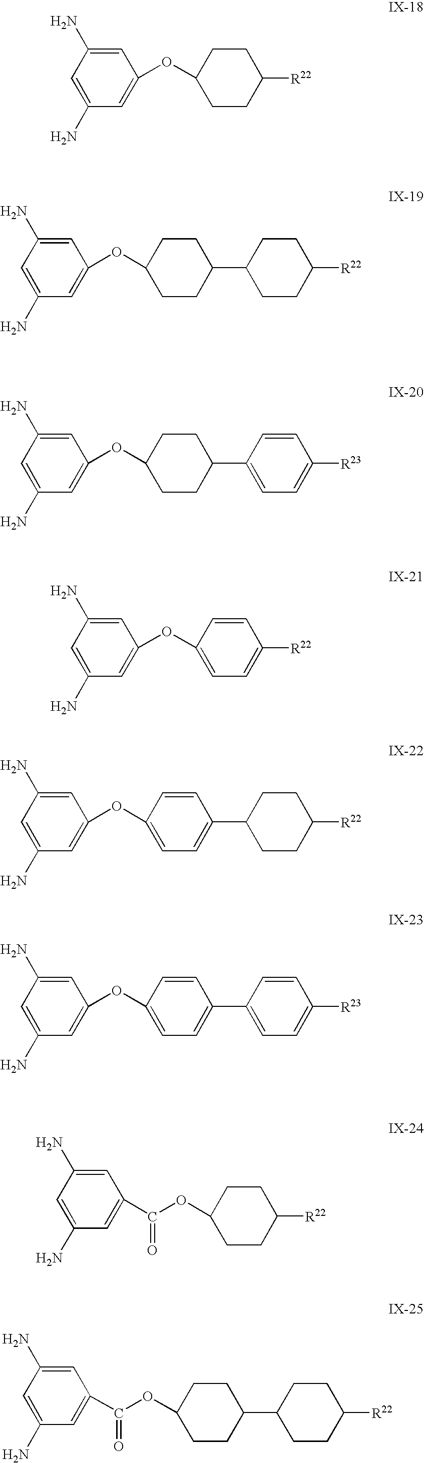

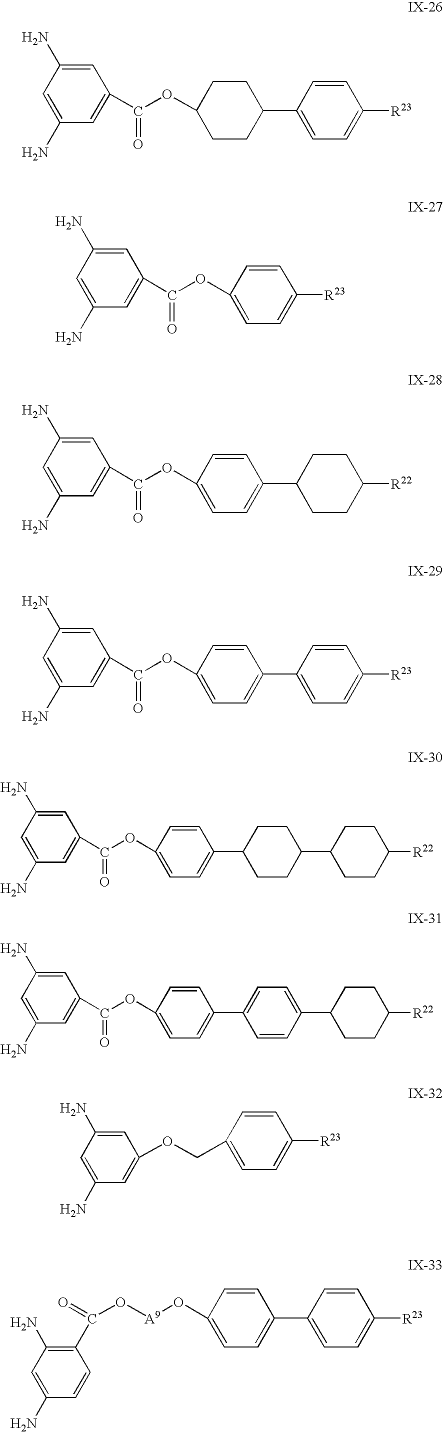

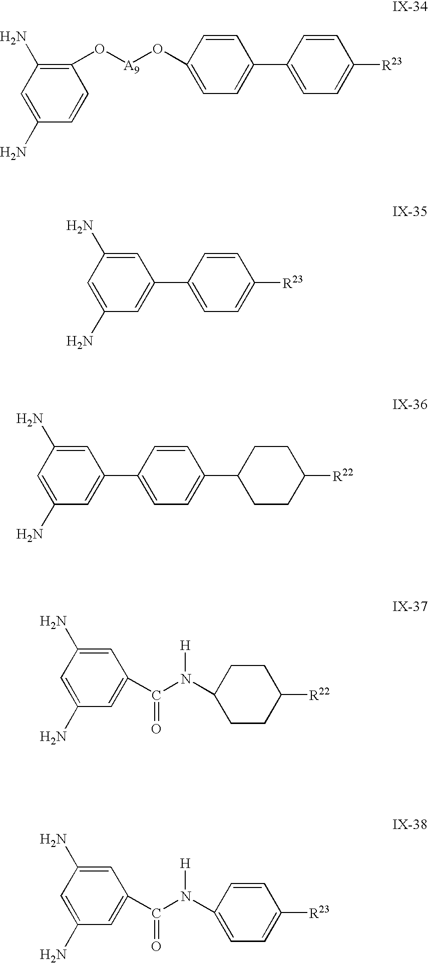

In formulas (IX-18), (IX-19), (IX-22), (IX-24), (IX-25), (IX-28), (IX-30), (IX-31), (IX-36) and (IX-37) above, R²² represents an alkyl having 1 to 12 carbon atoms or an alkoxy having 1 to 12 carbon atoms, and preferably an alkyl having 3 to 12 carbon atoms or an alkoxy having 3 to 12 carbon atoms. In formulas (IX-20), (IX-21), (IX-23), (IX-26), (IX-27), (IX-29), (IX-32) to (IX-35) and (IX-38) above, R²³ represents an —H, —F, alkyl having 1 to 12 carbon atoms, alkoxy having 1 to 12 carbon atoms, —CN, —OCH₂F, —OCHF₂ or —OCF₃, and preferably represents an alkyl having 3 to 12 carbon atoms or alkoxy having 3 to 12 carbon atoms. In formulas (IX-33) and (IX-34) above, A⁹ represents an alkylene having 1 to 12 carbon atoms.

Additional examples of diamines represented by general formula (IX) include the diamines represented by the following formulas (IX-39) to (IX-48).

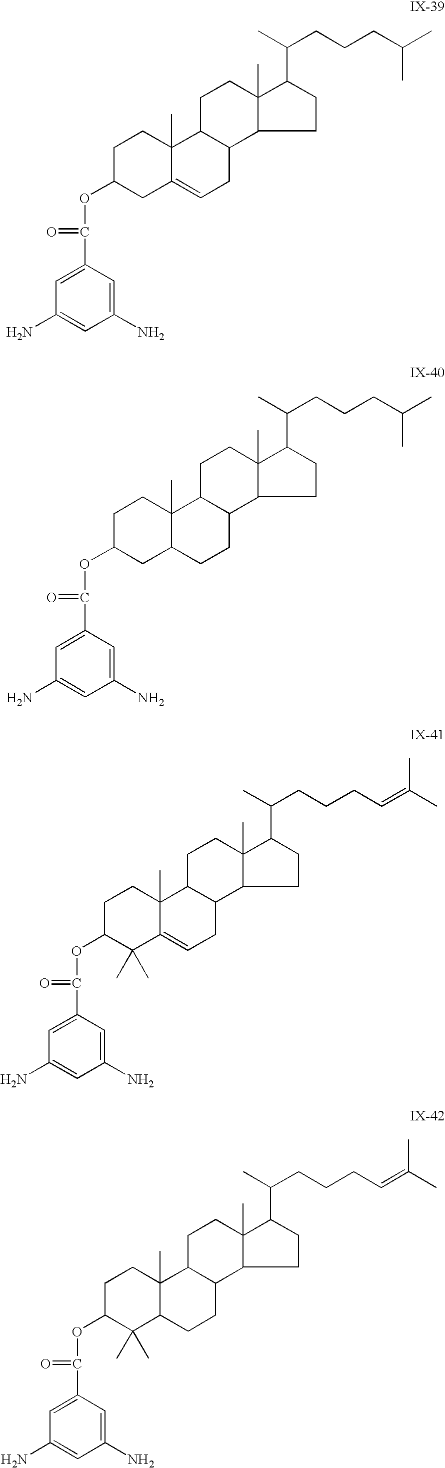

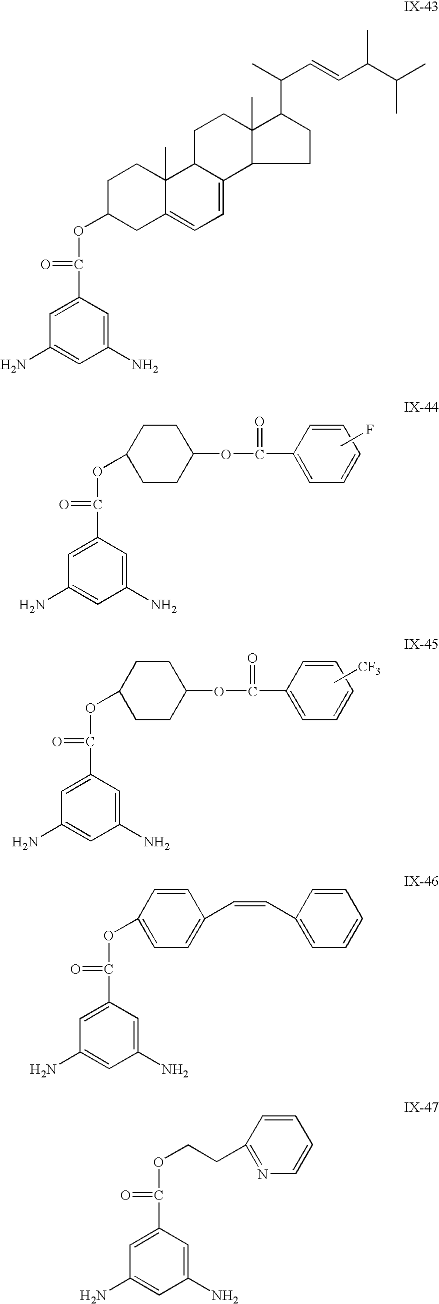

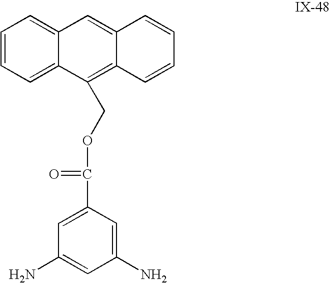

Among the diamines (b1) represented by general formula (IX), diamines represented by formulas (IX-1) to (IX-11) are preferable, while diamines represented by formula (IX-2), (IX-4), (IX-5) and (IX-6) are more preferable.

In the invention, examples of diamine (b1) used to synthesize compound (B) further include compounds represented by the following general formulas (XI) and (XII):

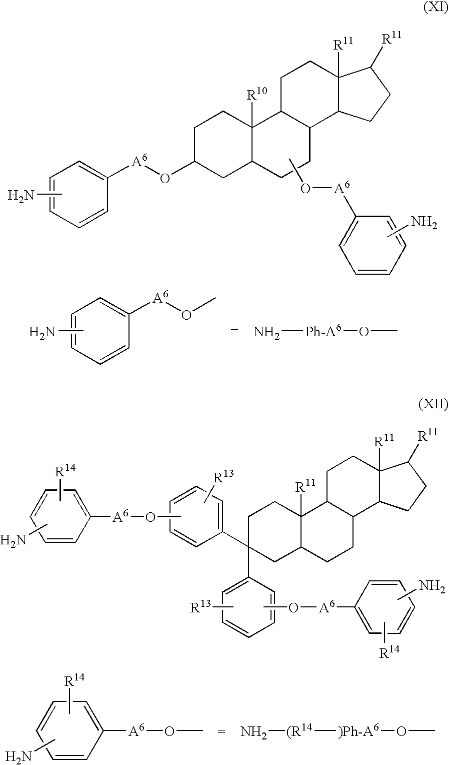

wherein formulas (XI) and (XII), R¹⁰ represents —H or —CH₃; R¹¹ respectively and independently represent —H, an alkyl having 1 to 20 carbon atoms or an alkenyl having 2 to 20 carbon atoms; A⁶ respectively and independently represent a single bond, —C(═O)— or —CH₂—; and R¹³ and R¹⁴ respectively and independently represent —H, an alkyl having 1 to 20 carbon atoms or a phenyl).

In general formula (XI) above, one of the two “NH₂-Ph-A⁶-O—” is preferably bonded to position 3 of the steroid core, while the other is preferably bonded to position 6. In addition, the two amino groups are preferably respectively bonded to a carbon of the phenyl ring, and bonded at the meta position or para position with respect to the bonding position of A⁶.

Examples of diamines represented by general formula (XI) include the diamines represented by the following formulas (XI-1) to (XI-4).

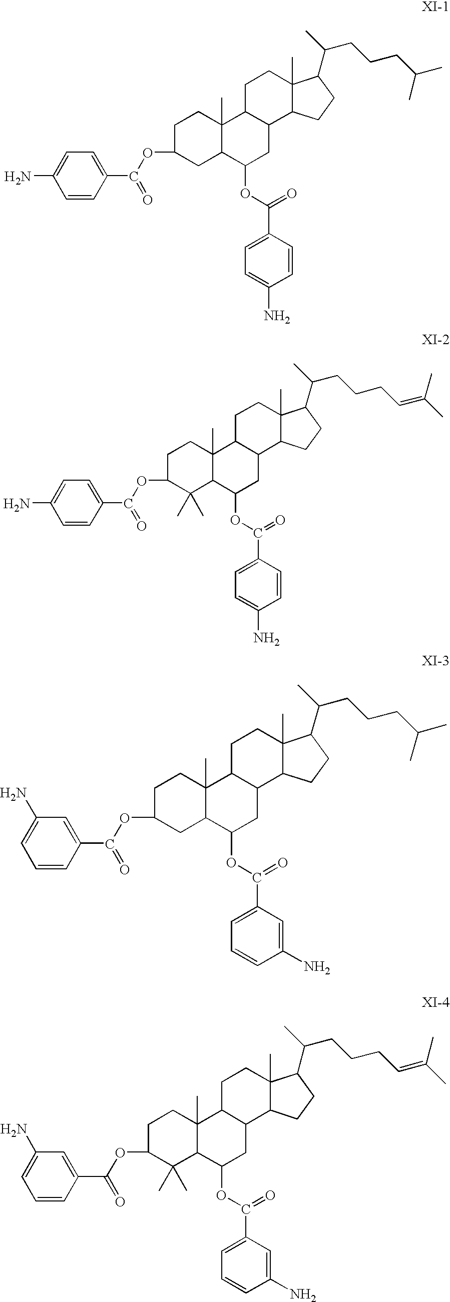

In general formula (XII), the two “NH₂—(R¹⁴-)Ph-A⁶-O—” are respectively bonded to a carbon of the phenyl ring, they are preferably bonded to a carbon in the meta position or para position with respect to carbons bonded to the steroid core. In addition, although the two amino groups are respectively bonded to carbons of the phenyl ring, they are preferably bonded in the meta position or para position with respect to A⁶.

Examples of diamines represented by general formula (XII) include the diamines represented by the following formulas (XII-1) to (XII-8).

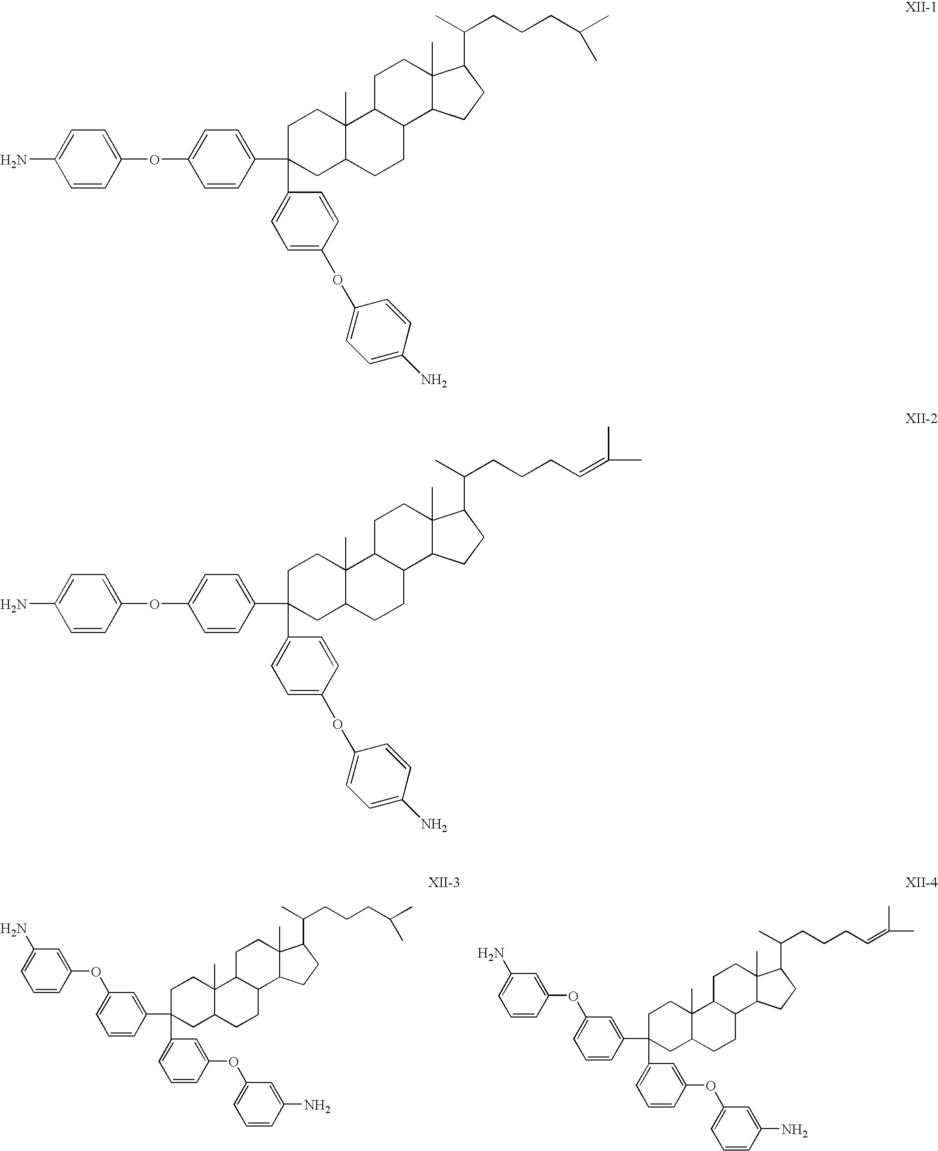

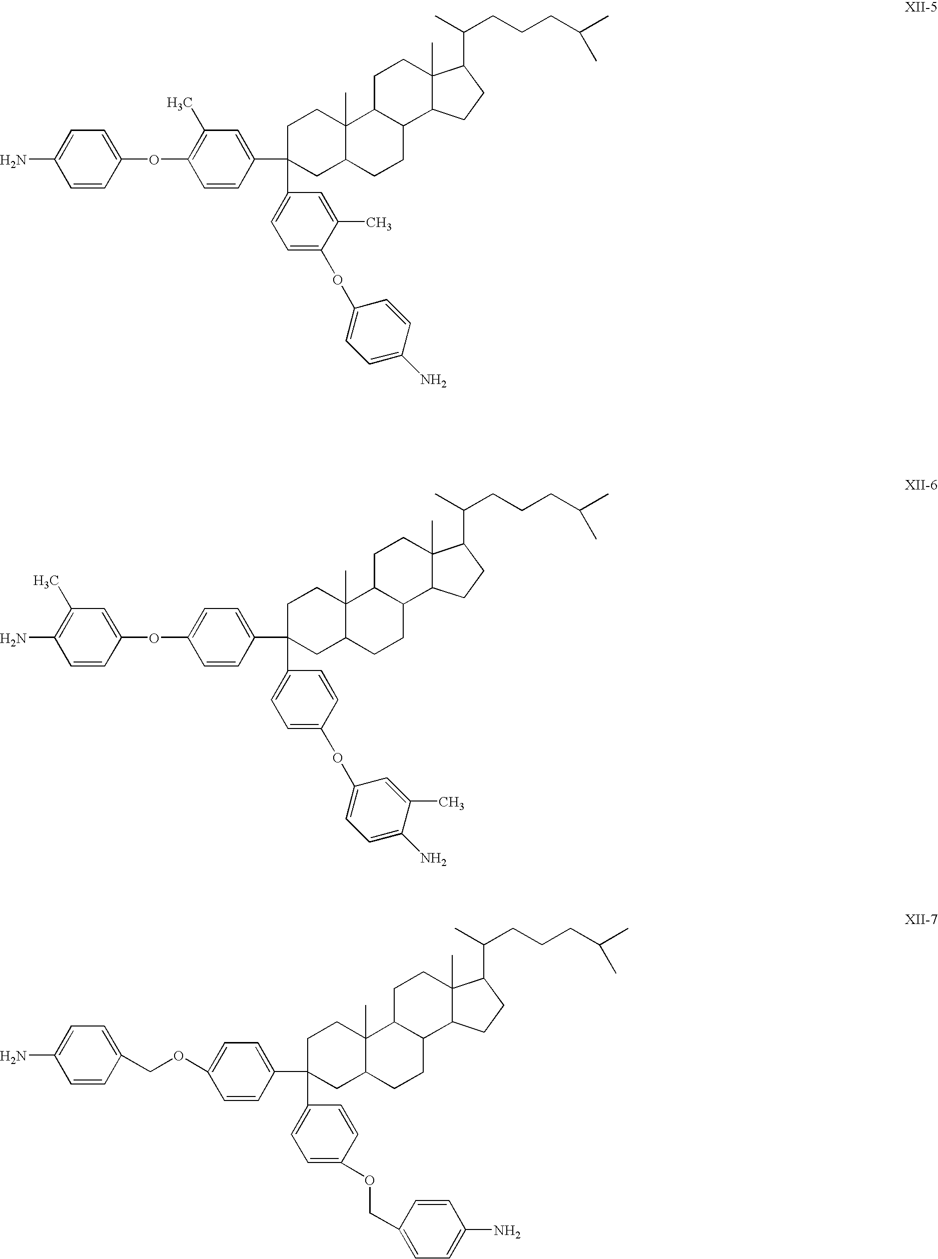

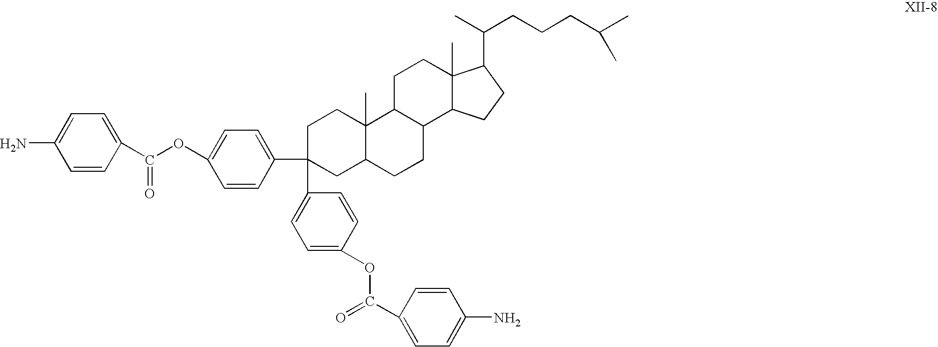

In the invention, examples of diamine (b1) used to synthesize compound (B) further include the compounds represented by general formulas (XIII) and (XIV):

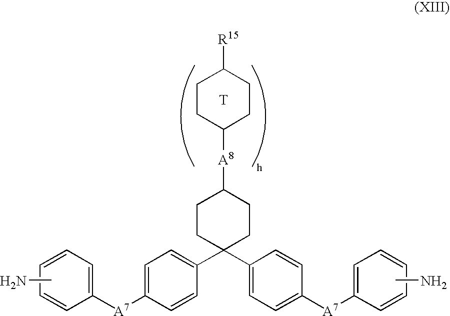

wherein formula (XIII), R¹⁵ represents —H or an alkyl having 1 to 20 carbon atoms, and an arbitrary —CH₂— of those alkyls having 2 to 20 carbon atoms may be replaced by —O—,—CH═CH— or —C≡C—; A⁷ respectively and independently represents —O— or an alkylene having 1 to 6 carbon atoms; A⁸ represents a single bond or an alkylene having 1 to 3 carbon atoms; ring T represents 1,4-phenylene or 1,4-cyclohexylene; and h represents 0 or 1);

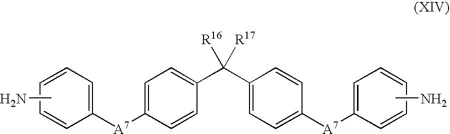

wherein formula (XIV), R¹⁶ represents an alkyl having 2 to 30 carbon atoms; R¹⁷ represents —H or an alkyl having 1 to 30 carbon atoms; and A⁷ respectively and independently represents —O— or an alkylene having 1 to 6 carbon atoms.

In formula (XIII) above, the two amino groups are respectively bonded to carbons of a phenyl ring, they are preferably bonded in the meta or para position with respect to A⁷.

Examples of diamines represented by general formula (XIII) include the diamines represented by formulas (XIII-1) to (XIII-9).

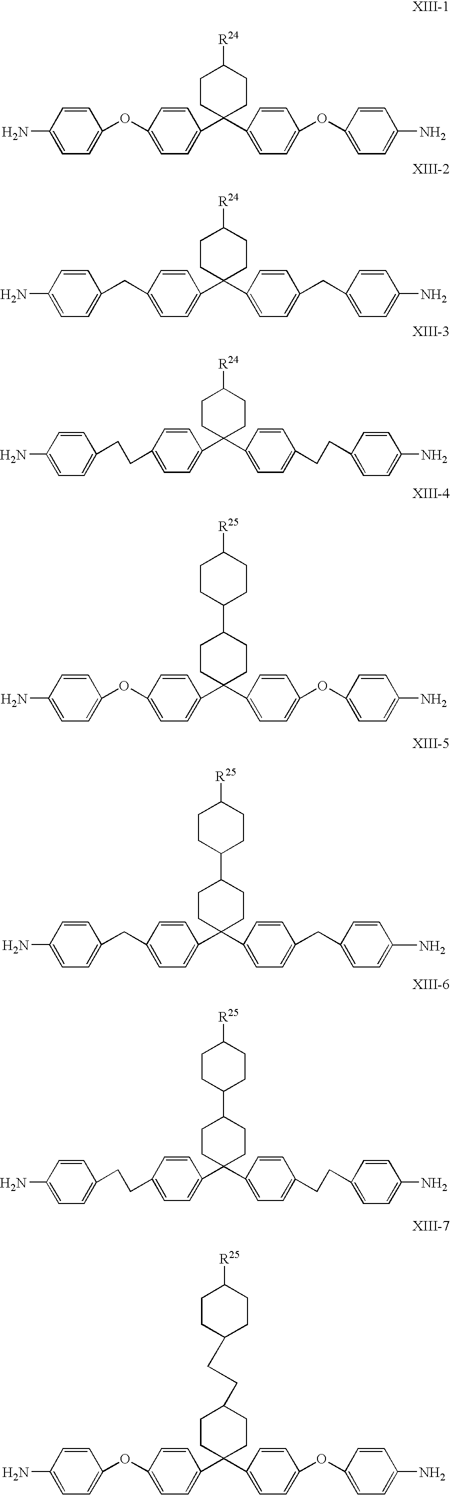

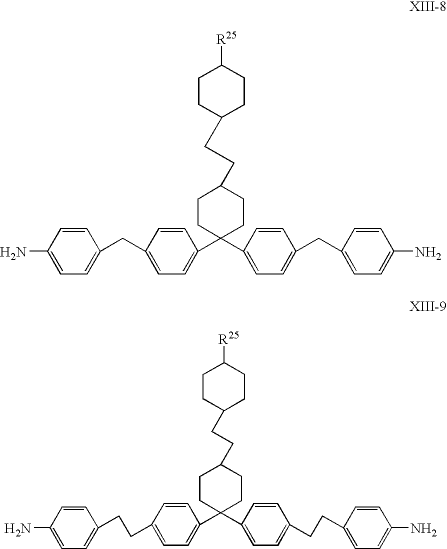

In formulas (XIII-1) to (XIII-3) above, R²⁴ is preferably —H or an alkyl having 1 to 20 carbon atoms, and in formulas (XIII-4) to (XIII-9), R²⁵ is more preferably —H or an alkyl having 1 to 10 carbon atoms.

In the aforementioned general formula (XIV), the two amino groups are respectively bonded to carbons of a phenyl ring, they are preferably bonded in the meta or para position with respect to A⁷.

Examples of diamines represented by general formula (XIV) include the diamines represented by formulas (XIV-1) to (XIV-3).

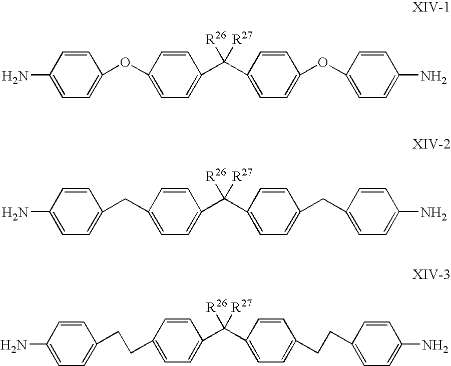

In formulas (XIV-1) to (XIV-3), R²⁶ is an alkyl having 2 to 30 carbon atoms and preferably an alkyl having 6 to 20 carbon atoms, while R²⁷ is —H or an alkyl having 1 to 30 carbon atoms and preferably —H or an alkyl having 1 to 10 carbon atoms.

As previously described, although a diamine represented by, for example, general formulas (I) to (XIV) can be used for diamine (b1) used to synthesize compound (B) in the invention, diamines other than these diamines can also be used. For example, naphthalene-based diamines having a naphthalene structure, fluorene-based diamines having a fluorene structure, or siloxane-based diamines having a siloxane structure can be used either alone or mixed with other diamines.

Although there are no particular limitations on siloxane-based diamines, those represented by the following formula (4) can be used preferably in the invention.

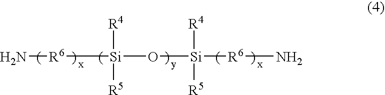

wherein, R⁴ and R⁵ independently represent an alkyl having 1 to 3 carbon atoms or a phenyl, R⁶ independently represents a methylene, phenylene or alkyl-substituted phenylene, x independently represents an integer of 1 to 6, y represents an integer of 1 to 70, and y preferably represents an integer of 1 to 15.

As used herein, an “alkyl” in the “alkyl-substituted phenylene” is preferably an alkyl having 2 to 10 carbon atoms, and more preferably an alkyl having 2 to 6 carbon atoms, examples of which include, but are not limited to, an ethyl, propyl, isopropyl, butyl, s-butyl, t-butyl, pentyl, hexyl or decanyl.

Among the diamines represented by general formulas (I) to (VIII) and general formula (4), the use of 4,4′-diaminodiphenylsulfone, 3,3′-diaminodiphenylsulfone, 3,4′-diaminodiphenylsulfone, bis[4-(4-aminophenoxy)phenyl]sulfone, bis[4-(3-aminophenoxy)phenyl]sulfone, bis[3-(4-aminophenoxy)phenyl]sulfone, [4-(4-aminophenoxy)phenyl][3-(4-aminophenoxy)phenyl]sulfone, [4-(3-aminophenoxy)phenyl][3-(4-aminophenoxy)phenyl]sulfone, 4,4′-diaminodiphenyl ether, 4,4′-diaminodiphenyl methane, 3,3′-diaminodiphenyl methane, 3,3′-dimethyl-4,4′-diaminodiphenyl methane, 2,2-bis[4-(4-aminophenoxy)phenyl]propane, 2,2-bis[4-(4-aminophenoxy)phenyl]hexafluoropropane or a compound represented by the aforementioned formula (4) increases adhesion between a cured film of the resulting ink-jet ink and a polyimide substrate and the like, thereby making this preferable.

In particular, a cured film of an ink-jet ink obtained by using 4,4′-diaminodiphenylsulfone, 3,3′-diaminodiphenylsulfone, 4,4′-diaminodiphenyl methane, 3,3′-diaminodiphenyl methane, 3,3′-dimethyl-4,4′-diaminodiphenyl methane, 2,2-bis[4-(4-aminophenoxy)phenyl]hexafluoropropane, 4,4′-diaminodiphenyl ether, 2,2′-diaminodiphenylpropane and a compound represented by formula (4) has increased adhesion with a polyimide substrate and the like, thereby making this preferable.

Furthermore, diamine (b1) able to be used to synthesize compound (B) contained in the ink-jet ink of the invention is not limited to the diamines of the present description, and various other types of diamines can be used within a range that allows the object of the invention to be achieved.

In addition, diamine (b1) able to be used to synthesize compound (B) contained in the ink-jet ink of the invention can be used alone or two or more types can be used in combination. Namely, two or more of the aforementioned diamines, the aforementioned diamines and other diamines, or two or more diamines other than the aforementioned diamines can be used for the combination of two or more types of diamines.

(4) Compound (b2) Having Two or More Acid Anhydride Groups

In the invention, specific examples of compound (b2) having two or more acid anhydride groups able to be used to synthesize compound (B) include aromatic tetracarboxylic dianhydrides such as styrene-maleic anhydride copolymers, styrene-maleic anhydride-(meth)acrylic acid copolymers, methyl (meth)acrylic acid-maleic anhydride copolymers, methyl(meth)acrylic acid-maleic anhydride-(meth)acrylic acid copolymers, styrene-itaconic anhydride copolymers, styrene-itaconic anhydride-(meth)acrylic acid copolymers, methyl(meth)acrylic acid-itaconic anhydride copolymers, methyl(meth)acrylic acid-itaconic anhydride-(meth)acrylic acid copolymers, 2,2′,3,3′-benzophenone tetracarboxylic dianhydride, 2,3,3′,4′-benzophenone tetracarboxylic dianhydride, 2,2′,3,3′-diphenylsulfone tetracarboxylic dianhydride, 2,3,3′,4′-diphenylsulfone tetracarboxylic dianhydride, 3,3′,4,4′-diphenyl ether tetracarboxylic dianhydride, 2,2′,3,3′-diphenyl ether tetracarboxylic dianhydride, 2,3,3′,4′-diphenyl ether tetracarboxylic dianhydride, 2,2-[bis(3,4-dicarboxyphenyl)]hexafluoropropane dianhydride and ethylene glycol bis(anhydromellitate) (product name: TMEG-100, New Japan Chemical Co., Ltd.), and tetracarboxylic dianhydrides such as ethane tetracarboxylic dianhydride, 4-(2,5-dioxotetrahydrofuran-3-yl)-1,2,3,4-tetrahydronaphthalene-1,2-dicarboxylic anhydride, 5-(2,5-dioxotetrahydrofuryl)-3-methyl-3-cyclohexene-1,2-dicarboxylic anhydride and compounds represented by the following formulas b2-1 to b2-73.

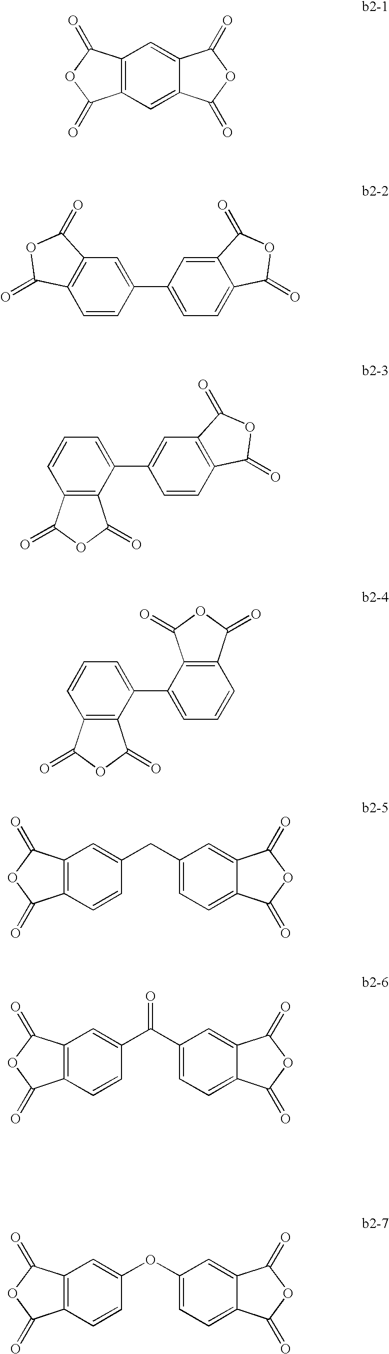

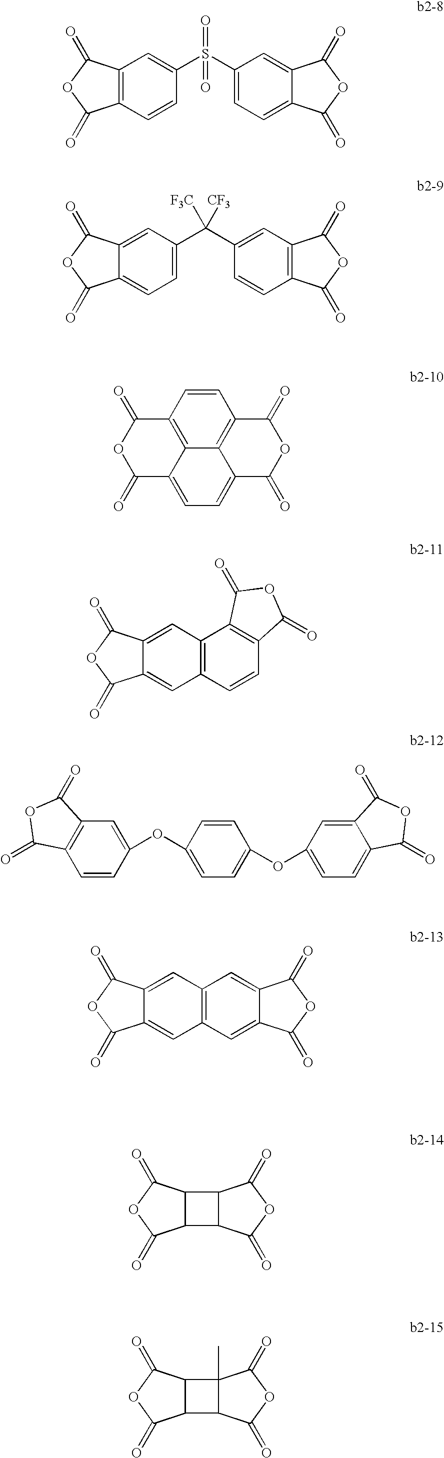

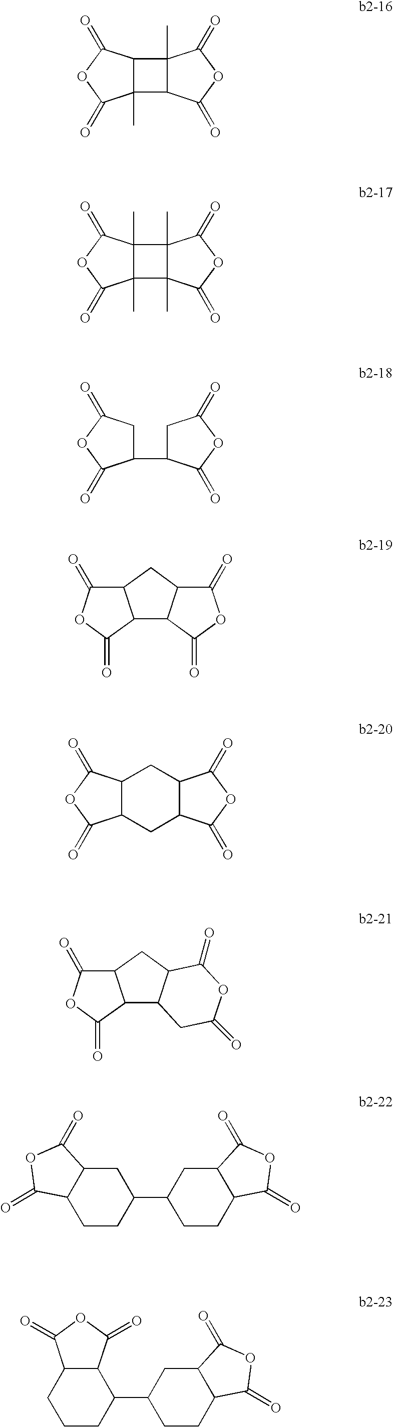

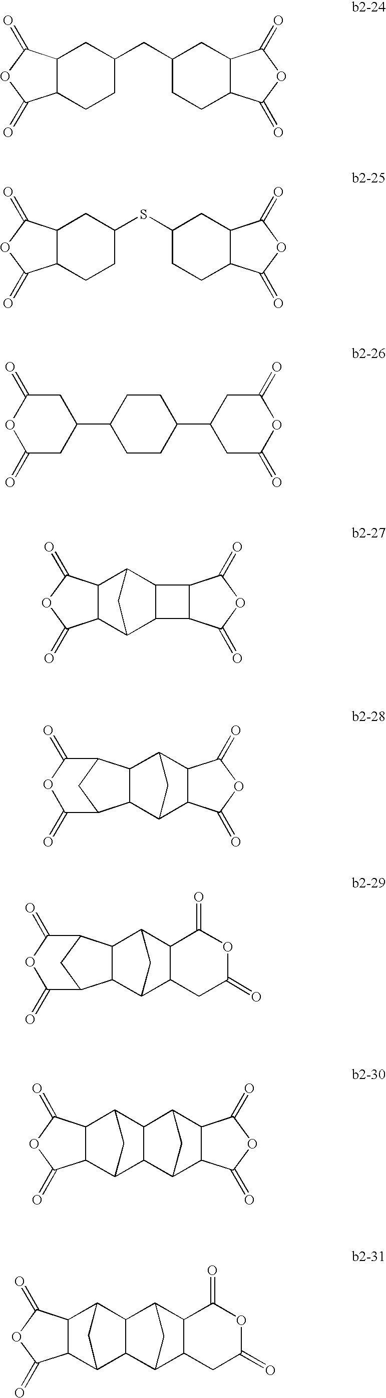

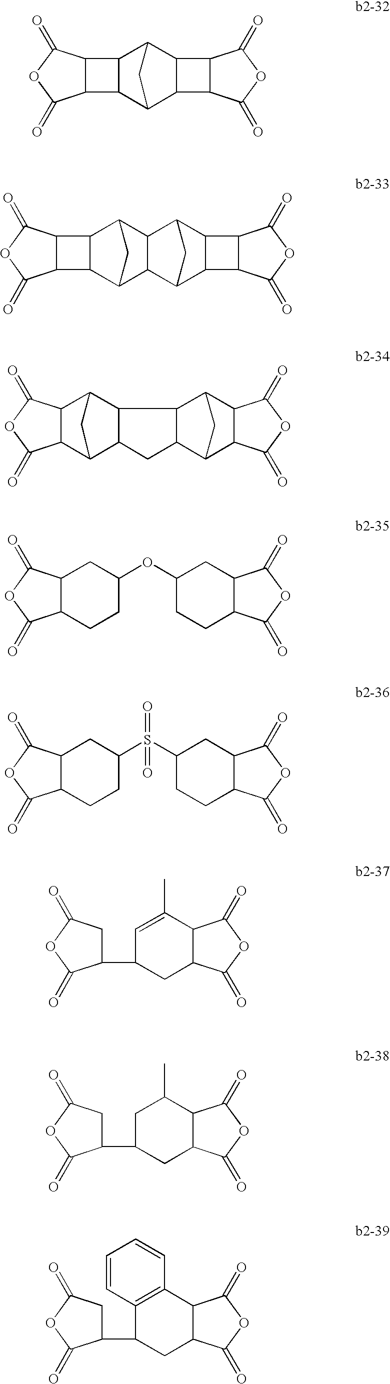

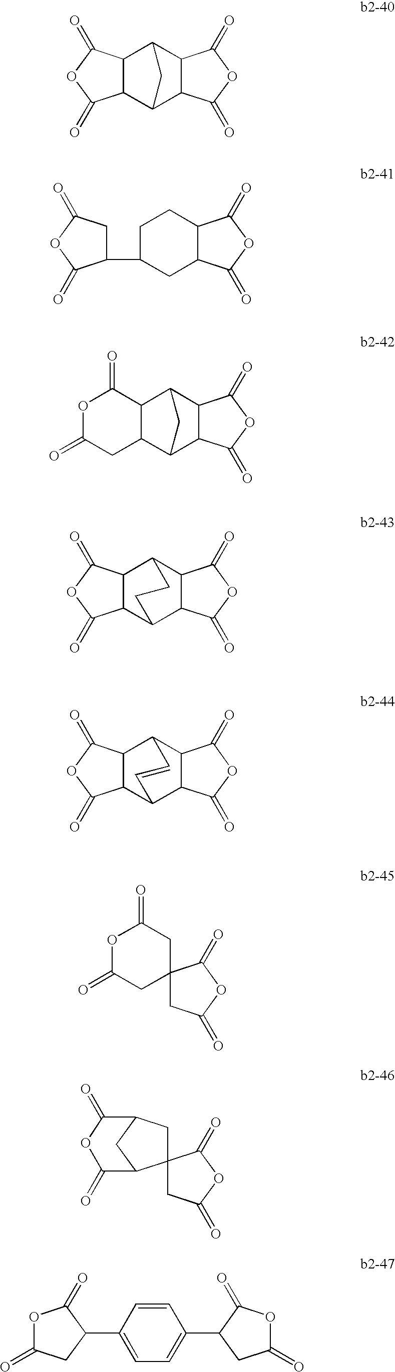

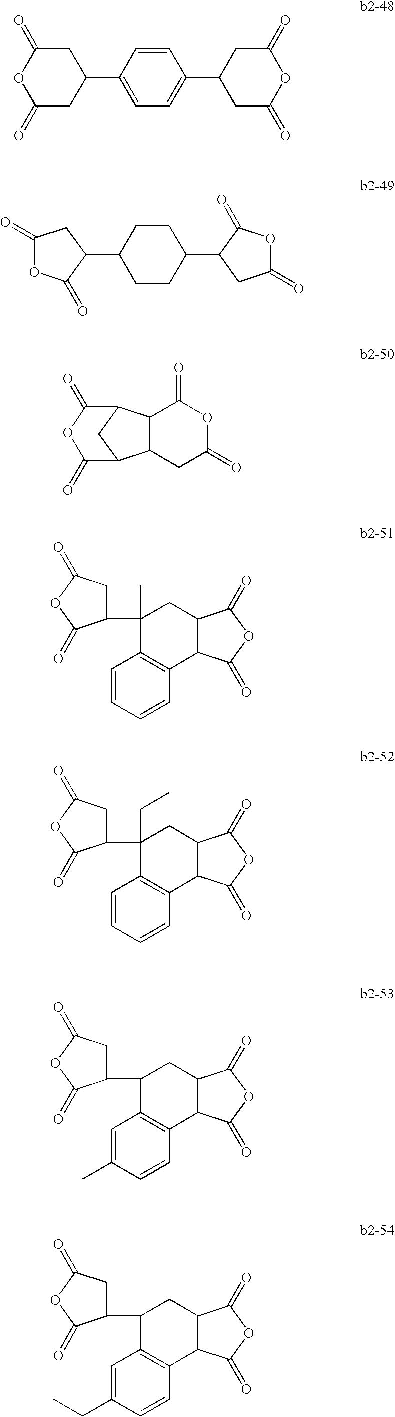

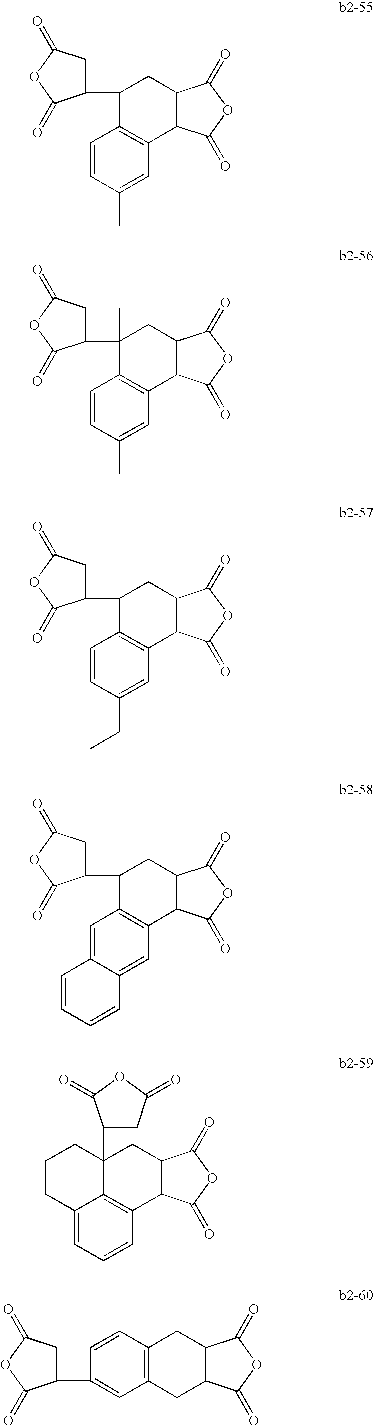

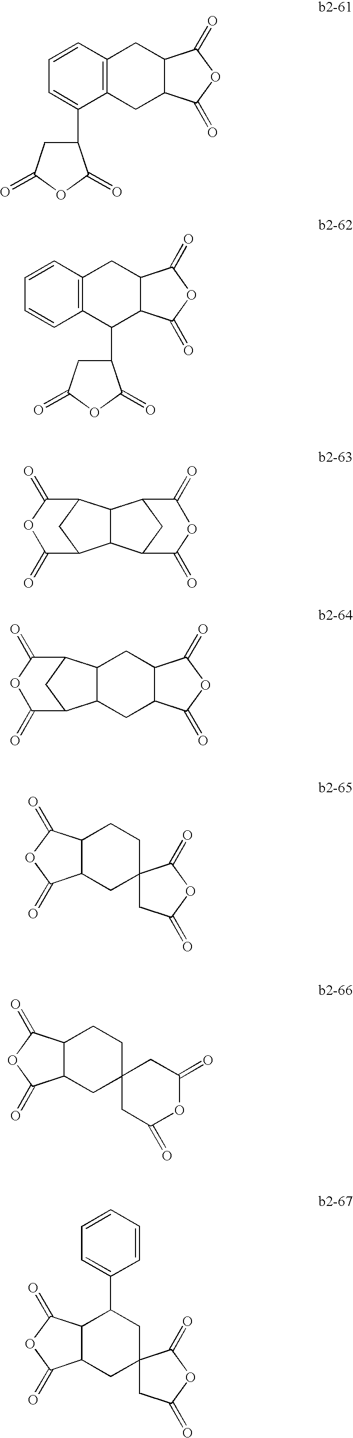

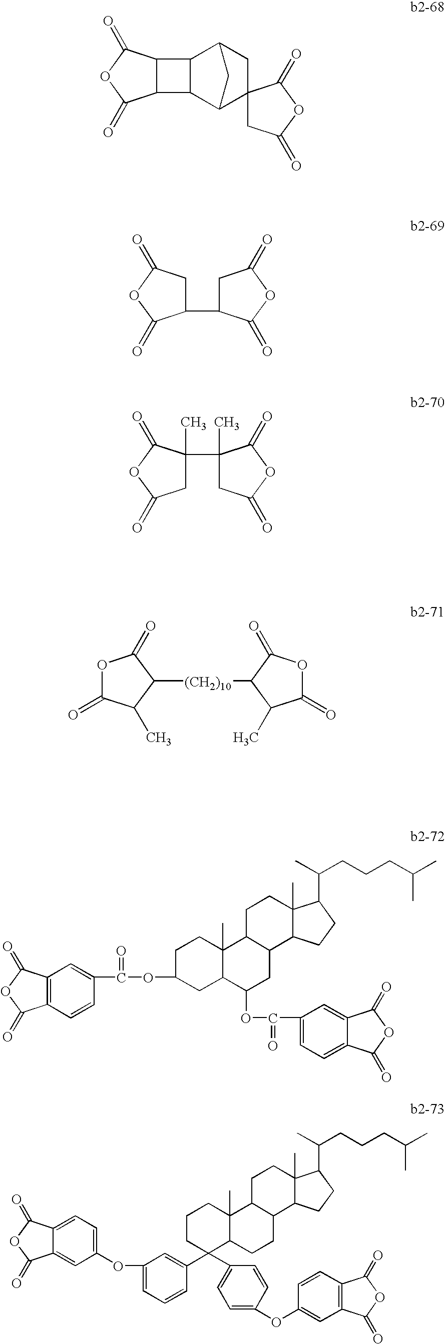

Among the above-mentioned specific examples of compound (b2) having two or more acid anhydride groups, the use of a styrene-maleic anhydride copolymer, styrene-maleic anhydride-(meth)acrylic acid copolymer, methyl(meth)acrylic acid-maleic anhydride copolymer, pyromellitic dianhydride (b2-1), cyclobutane tetracarboxylic dianhydride (b2-14), butane tetracarboxylic dianhydride (b2-18), 1,2,4,5-cyclohexane tetracarboxylic dianhydride (b2-20), 3,3′,4,4′-diphenylsulfone tetracarboxylic dianhydride, (b2-8), 3,3′,4,4′-diphenyl ether tetracarboxylic dianhydride or 3,3′,4,4′-benzophenone tetracarboxylic dianhydride (b2-6) increases adhesion between a cured film of the resulting ink-jet ink and a polyimide substrate and the like, thereby making this preferable.

In particular, a cured film of an ink-jet ink obtained using styrene-maleic anhydride copolymer, pyromellitic dianhydride, butane tetracarboxylic dianhydride, 3,3′,4,4′-diphenylsulfone tetracarboxylic dianhydride and 3,3′,4,4′-diphenyl ether tetracarboxylic dianhydride has increased adhesion with a polyimide substrate and the like, thereby making this preferable.

Furthermore, compound (b2) having two or more acid anhydride groups able to be used to synthesize compound (B) contained in the ink-jet ink of the invention is not limited to the compounds of the present description, and various other types of compounds having two or more acid anhydride groups can be used within a range that allows the object of the invention to be achieved.

In addition, compound (b2) having two or more acid anhydride groups able to be used to synthesize compound (B) contained in the ink-jet ink of the invention can be used alone or two or more types can be used in combination. Namely, two or more of the compounds having the aforementioned acid anhydride groups, the compounds having two or more aforementioned acid anhydride groups and compounds having other acid anhydride groups, or two or more compounds having acid anhydride groups other than the compounds having two or more aforementioned acid anhydride groups, can be used for the combination of two or more types of compounds.

(5) Monovalent Alcohol

Compound (B) used in the invention may be reacted by introducing a monovalent alcohol in the case of having an acid anhydride group on the end of a molecule thereof. A monovalent alcohol is introduced into the reaction system either simultaneous to diamine (b1) or compound (b2) having two or more acid anhydride groups, or after introducing diamine (b1) and compound (b2) having two or more acid anhydride groups. A compound (B) obtained by reacting by introducing a monovalent alcohol is preferable due to its favorable flatness.

Specific examples of monovalent alcohols introduced include methanol, ethanol, 1-propanol, isopropyl alcohol, allyl alcohol, benzyl alcohol, hydroxethyl methacrylate, propylene glycol monoethyl ether, propylene glycol monomethyl ether, dipropylene glycol monoethyl ether, dipropylene glycol monomethyl ether, ethylene glycol monoethyl ether, ethylene glycol monomethyl ether, diethylene glycol monoethyl ether, diethylene glycol monomethyl ether, phenol, borneol, maltol, linalool, terpineol, dimethylbenzyl carbinol, ethyl lactate, glycidol and 3-ethyl-3-hydroxymethyl oxetane.

Among these, isopropyl alcohol, benzyl alcohol, hydroxyethyl methacrylate, propylene glycol monoethyl ether and 3-ethyl-3-hydroxymethyl oxetane are preferable, and the use of benzyl alcohol causes the resulting coated film to be flat, thereby making this preferable.

(6) Other Raw Materials

Reacting a silicon-containing monoamine, such as 3-aminopropyl trimethoxysilane, 3-aminopropyl triethoxysilane, 3-aminopropylmethyl dimethoxysilane, 3-aminopropylmethyl diethoxysilane, 4-aminobutyl trimethoxysilane, 4-aminobutyl triethoxysilane, 4-aminobutylmethyl diethoxysilane, p-aminophenyl trimethoxysilane, p-aminophenyl triethoxysilane, p-aminophenylmethyl dimethoxysilane, p-aminophenylmethyl diethoxysilane, m-aminophenyl trimethoxysilane or m-aminophenylmethyl diethoxysilane, or a carboxyl group-containing monoamine such as 4-aminobenzoic acid, with a polyamide acid having an acid anhydride group on the end of a molecule thereof improves the chemical resistance of a coated film formed from an ink-jet ink containing the resulting compound (B), thereby making this preferable.

(7) Reaction Conditions

Compound (B) is preferably obtained by reacting approximately 0.8 to approximately 1.2 moles, and more preferably approximately 0.9 to approximately 1.1 moles, of the anhydride groups of compound (b2) having two or more acid anhydride groups to approximately 1 mole of the amino groups of diamine (b1).

In addition, although there are no particular limitations on the solvent used in the synthesis reaction of compound (B), it is preferably a solvent that is capable of dissolving compound (B).

Examples of reaction solvents for synthesizing compound (B) include diethylene glycol dimethyl ether, diethylene glycol diethyl ether, diethylene glycol methyl ethyl ether, diethylene glycol monoethyl ether acetate, ethylene glycol monoethyl ether acetate, propylene glycol monomethyl ether acetate, methyl 3-methoxypropionate, ethyl 3-ethoxypropionate, cyclohexanone, N-methyl-2-pyrrolidone and N,N-dimethylacetoamide. Among these, propylene glycol monomethyl ether acetate, methyl 3-methoxypropionate, diethylene glycol methyl ethyl ether and N-methyl-2-pyrrolidone are preferable.

These reaction solvents can be used alone or two or more types can be used as a mixed solvent. In addition, other solvents besides the reaction solvents listed above can also be mixed and used provided the ratio thereof is approximately 50% by weight or less.

The use of approximately 100 parts by weight or more of reaction solvent to a total of approximately 100 parts by weight for diamine (b1), compound (b2) having two or more acid anhydride groups and an optionally contained monovalent alcohol, monoamine and the like is preferable since it enables the synthesis reaction to proceed smoothly. The reaction is preferably carried out for approximately 0.2 to approximately 20 hours at approximately 40 to approximately 200° C. In the case of reacting a silicon-containing monoamine, the reaction may be carried out for approximately 0.1 to approximately 6 hours at approximately 10 to approximately 40° C. by introducing the silicon-containing monoamine after having cooled the reaction solution to approximately 40° C. or lower following completion of the reaction between diamine (b1) and compound (b2) having two or more acid anhydride groups.

Furthermore, the reaction may also be carried out by adding a monovalent alcohol to polyamide acid (B).

(8) Order of Addition to Reaction System

There are no particular limitations on the order in which reaction raw materials are introduced into the reaction system. Namely, any method of either simultaneously adding diamine (b1) and compound (b2) having two or more acid anhydride groups to the reaction solvent, introducing compound (b2) having two or more acid anhydride groups after having dissolved diamine (b1) in the reaction solvent, or introducing diamine (b1) after having dissolved compound (b2) having two or more acid anhydride groups in the reaction solvent, can be used.

2.2 Compound (A) (Polyester-Polyamide Acid)

The ink-jet ink of the invention may further contain a compound (A) having structural units represented by formulas (1) and (2). If compound (A) is contained in the ink-jet ink, the adhesion of the resulting coated film to a substrate on which the ink is coated, and particularly a polyimide substrate, increases, thereby making this preferable.

(1) Structural Units Contained in Compound (A)

In the above-mentioned formulas (1) and (2), although R¹ respectively represents an organic group having 2 to 100 carbon atoms, this R¹ is a residue of a compound having two or more acid anhydride groups, and preferably a tetracarboxylic anhydride residue or styrene-maleic anhydride copolymer residue. In addition, in the formulas (1) and (2), although R² and R³ respectively represent an organic group having 2 to 100 carbon atoms, this R² is a diamine residue and R³ is a polyvalent hydroxy compound residue, and preferably a diol residue.

Although a high molecular weight is preferable in terms of the chemical resistance of the ink-jet ink of the invention, on the other hand, since a low molecular weight is preferable in terms of solubility in solvent, the weight average molecular weight of the polyester-polyamide acid is preferably approximately 1,000 to approximately 500,000 and more preferably approximately 2,000 to approximately 200,000.

There are no particular limitations on the concentration of compound (A) in the ink-jet ink of the invention, approximately 0.1 to approximately 50% by weight is preferable and a concentration of approximately 0.5 to approximately 20% by weight is more preferable since it becomes easier to coat with an ink jet from the viewpoint of ink viscosity.

(2) Production Process of Compound (A)

Compound (A) contained in the ink-jet ink of the invention is obtained by, for example, reacting at least a polyvalent hydroxy compound (a1), a diamine (a2) and a compound (a3) having two or more acid anhydride groups. As used herein, a polyvalent hydroxy compound refers to a compound having two or more hydroxyl groups.

Although compound (A) obtained in this manner preferably has structural units represented by the above-mentioned formulas (1) and (2), it is not limited to having these structural units.

Diamine (a2) capable of being used to obtain compound (A) is similar to diamine (b1) capable of being used to obtain compound (B). In addition, compound (a3) having two or more acid anhydride groups capable of being used to obtain compound (A) is similar to compound (b2) having two or more acid anhydride groups capable of being used to obtain compound (B). Therefore, the following provides an explanation of polyvalent hydroxy compound (a1) capable of being used to obtain compound (A).

(3) Polyvalent Hydroxy Compound (a1)

In the invention, specific examples of polyvalent hydroxy compounds that can be used to obtain compound (A) include ethylene glycol, diethylene glycol, triethylene glycol, tetraethylene glycol, polyethylene glycol having a molecular weight of approximately 1,000 or less, propylene glycol, dipropylene glycol, tripropylene glycol, tetrapropylene glycol, polypropylene glycol having a molecular weight of approximately 1,000 or less, 1,2-butariediol, 1,3-butanediol, 1,4-butanediol, 1,2-pentanediol, 1,5-pentanediol, 2,4-pentanediol, 1,2,5-pentanetriol, 1,2-hexanediol, 1,6-hexanediol, 2,5-hexanediol, 1,2,6-hexanetriol, 1,2-heptanediol, 1,7-heptanediol, 1,2,7-heptanetriol, 1,2-octanediol, 1,8-octanediol, 3,6-octanediol, 1,2,8-octanetriol, 1,2-nonanediol, 1,9-nonanediol, 1,2,9-nonanetriol, 1,2-decanediol, 1,10-decanediol, 1,2,10-decanetriol, 1,2-dodecanediol, 1,12-dodecanediol, glycerin, trimethylol propane, pentaerythritol, dipentaerythritol, bisphenol A (product name), bisphenol S (product name), bisphenol F (product name), diethanolamine, triethanolamine, SEO-2 (trade name, Nicca Chemical Co., Ltd.), SKY CHDM, Rikabinol HB (both are product names, New Japan Chemical Co., Ltd.) and Silaplane FM-4411 (product name, Chisso Corp.).

Diols are preferable among the specific examples of polyvalent hydroxy compounds, and a cured film formed from an ink-jet ink containing compound (A) obtained using ethylene glycol, diethylene glycol, triethylene glycol, tetraethylene glycol, propylene glycol, dipropylene glycol, tripropylene glycol, tetrapropylene glycol, 1,4-butanediol, 1,5-pentanediol or 1,6-hexandiol in particular is preferable since adhesion with a polyimide substrate is increased.

Furthermore, polyvalent hydroxy compound (a1) able to be used to synthesize compound (A) contained in the ink-jet ink of the invention is not limited to the polyvalent hydroxy compounds of the present description, and various other types of polyvalent hydroxy compounds can be used within a range that allows the object of the invention to be achieved.

In addition, polyvalent hydroxy compound (a1) able to be used to synthesize compound (A) contained in the ink-jet ink of the invention can be used alone or two or more types can be used in combination. Namely, two or more of the aforementioned polyvalent hydroxy compounds, the aforementioned polyvalent hydroxy compounds and other polyvalent hydroxy compounds, or two or more polyvalent hydroxy compounds other than the aforementioned polyvalent hydroxy compounds can be used for the combination of two or more types of polyvalent hydroxy compounds.

(4) Monovalent Alcohol

A monovalent alcohol is preferably introduced in the case compound (A) used in the invention has an acid anhydride group on the end of a molecule thereof. The same monovalent alcohols used to synthesize compound (B) can be used for the monovalent alcohol.

(5) Other Raw Materials

Similar to compound (B), reacting a silicon-containing monoamine, of which specific examples were previously listed, or a carboxyl group-containing monoamine such as 4-aminobenzoic acid, with compound (A) having an acid anhydride group on the end of a molecule thereof improves the chemical resistance of a coated film formed from the resulting ink-jet ink, thereby making this preferable.

(6) Reaction Conditions

Compound (A) is preferably obtained by reacting approximately 0.1 to approximately 10 moles of the amino groups of diamine (a2) and 1 to 10 moles of the anhydride groups of compound (a3) having two more acid anhydride groups to 1 mole of the hydroxyl groups of polyvalent hydroxy compound (a1). In addition, compound (A) is more preferably obtained by reacting approximately 0.2 to approximately 5 moles of the amino groups of diamine (a2) and approximately 1.1 to approximately 6 moles of the anhydride groups of compound (a3) having two or more acid anhydride groups to approximately 1 mole of the hydroxyl groups of polyvalent hydroxy compound (a1).

In addition, although there are no particular limitations on the solvent used in this reaction, it is preferably a solvent capable of dissolving compound (A), and more specifically, the same solvents can be used as the reaction solvents for synthesizing compound (B).

The use of approximately 100 parts by weight or more of reaction solvent to a total of approximately 100 parts by weight for polyvalent hydroxy compound (a1), diamine (a2), compound (a3) having two or more acid anhydride groups and an optionally contained monovalent alcohol, monoamine and the like is preferable since it enables the synthesis reaction to proceed smoothly. The reaction is preferably carried out for approximately 0.2 to approximately 20 hours at approximately 40 to approximately 200° C.

In the case of reacting a silicon-containing monoamine, the reaction may be carried out for approximately 0.1 to approximately 6 hours at approximately 10 to approximately 40° C. by introducing the silicon-containing monoamine after having cooled the reaction solution to approximately 40° C. or lower following completion of the reaction between polyvalent hydroxy compound (a1), diamine (a2) and compound (a3) having two or more acid anhydride groups. In addition, the monovalent alcohol is preferably introduced simultaneous to the polyvalent hydroxy compound.

(7) Order of Addition to Reaction System

There are no particular limitations on the order in which reaction raw materials are added to the reaction system. Namely, any method of either simultaneously adding polyvalent hydroxy compound (a1), diamine (a2) and compound (a3) having two or more acid anhydride groups to the reaction solvent, adding compound (a3) having two or more acid anhydride groups after having dissolved polyvalent hydroxy compound (a1) and diamine (a2) in the reaction solvent, synthesizing a copolymer in advance by reacting polyvalent hydroxy compound (a1) and compound (a3) having two or more acid anhydride groups followed by the addition of diamine (a2) to that copolymer, or synthesizing a copolymer in advance by reacting diamine (a2) and compound (a3) having two or more acid anhydride groups followed by adding polyvalent hydroxy compound (a1) to that polymer, can be used.

2.3 Polyester-Polyimide Compound

The ink-jet ink of the invention may also contain a polyester-polyimide compound. A polyester-polyimide compound is obtained by, for example, imidizing compound (A). Imidization is carried out by, for example, heating compound (A) for approximately 1 to approximately 20 hours at approximately 180 to approximately 300° C.

2.4 Epoxy Resin (D)

The ink-jet ink of the invention may further contain an epoxy resin (D). Although there are no particular limitations on epoxy resin (D) used in the invention provided it has an oxirane, compounds having two or more oxiranes are preferable.

Examples of epoxy resin (D) include bisphenol A epoxy resin, glycidyl ester epoxy resin, alicyclic epoxy resin, polymers of monomers having an oxirane and copolymers of monomers having an oxirane and other monomers.

Specific examples of epoxy resin (D) include product names “Epicoat 807”, “Epicoat 815”, “Epicoat 825”, “Epicoat 827”, “Epicoat 828” represented by the above-mentioned formula (8), “Epicoat 190P” and “Epicoat 191P” (all of which are manufactured by Yuka-Shell Epoxy Co., Ltd.), product names “Epicoat 1004” and “Epicoat 1256” (both of which are manufactured by Japan Epoxy Resin Co., Ltd.), product names “Araldite CY177” and “Araldite CY184 represented by the above-mentioned formula (5) (both of which are manufactured by Japan Ciba-Geigy Co., Ltd.), product names “Celoxide 2021 P” represented by the above-mentioned formula (6) and “EHPE-3150” (both of which are manufactured by Daicel Chemical Industries, Ltd.), and product name “Techmore VG3101L” represented by the above-mentioned chemical (7) (manufactured by Mitsui Chemicals Inc.).

Among these, use of “Epicoat 828” represented by formula (8), “Araldite CY184” represented by formula (5) (manufactured by Japan Ciba-Geigy Co., Ltd.), product name “Celoxide 2021P” represented by formula (6) (manufactured by Daicel Chemical Industries Ltd.) or product name “Techmore VG3101L” represented by formula (7) (manufactured by Mitsui Chemicals Inc.) results in favorable heat resistance of a cured film obtained from an ink-jet ink, thereby making this preferable.

In addition, specific examples of monomers having an oxirane for obtaining epoxy resin (D) include glycidyl(meth)acrylate, 3,4-epoxycyclohexyl(meth)acrylate and methylglycidyl(meth)acrylate.

Specific examples of other monomers polymerized with monomers having an oxirane for obtaining epoxy resin (D) include (meth)acrylic acid, methyl(meth)acrylate, ethyl(meth)acrylate, isopropyl(meth)acrylate, butyl(meth)acrylate, iso-butyl(meth)acrylate, t-butyl(meth)acrylate, cyclohexyl(meth)acrylate, benzyl(meth)acrylate, 2-hydroxyethyl(meth)acrylate, 2-hydroxypropyl(meth)acrylate, styrene, methyl styrene, chloromethyl styrene, (3-ethyl-3-oxetanyl)methyl(meth)acrylate, N-cyclohexyl maleimide and N-phenyl maleimide.

A preferable specific example of a polymer of a monomer having an oxirane capable of being used as epoxy resin (D) is polyglycidyl methacrylate. In addition, preferable specific examples of copolymers of monomers having an oxirane and other monomers capable of being used as epoxy resin include methyl methacrylate-glycidyl methacrylate copolymer, benzyl methacrylate-glycidyl methacrylate copolymer, butyl methacrylate-glycidyl methacrylate copolymer, 2-hydroxyethyl methacrylate-glycidyl methacrylate copolymer, (3-ethyl-3-oxetanyl)methyl methacrylate-glycidyl methacrylate copolymer and styrene-glycidyl methacrylate copolymer.

The concentration of epoxy resin in the ink-jet ink of the invention is preferably approximately 0.1 to approximately 20% by weight and more preferably approximately 0.2 to approximately 10% by weight since this results in favorable heat resistance of a cured film obtained from the ink-jet ink.

2.5 Acid Generator (E)

The ink-jet ink of the invention may further contain an acid generator (E).

A preferable acid generator (E) uniformly dissolves in a heat-curable composition, does not decompose ink-jet ink, and does not lower the film transparency of ink-jet ink. Examples of acid generator (E) include aromatic iodonium salts such as triaryl sulfonium salts, onium salts including aromatic iodonium salts such as diaryl iodonium salts, and nonionic initiators such as nitrobenzyl esters of sulfonic acid.

The concentration of acid generator (E) in the ink-jet ink of the invention is preferably approximately 10% by weight or less and preferably approximately 5% by weight or less.

2.6 Solvent

The ink-jet ink of the invention may further contain a solvent. There are no particular limitations on the solvent used in the invention provided it is able to dissolve fluorine-containing compound (C), copolymer (C′), compound (B), compound (A), epoxy resin (D) and the like.

The following lists examples of these solvents. Examples of aprotic polar organic solvents that are solvophilic with respect to compound (B) and compound (A) include N-methyl-2-pyrrolidone, dimethylimidazolidinone, N-methylcaprolactam, N-methylpropionamide, N,N-dimethylacetoamide, dimethylsulfoxide, N,N-dimethylformamide, N,N-diethylformamide, diethylacetoamide and γ-butyrolactone.

In addition, examples of solvents used for the purpose of improving coatability include alkyl lactate, 3-methyl-3-methoxybutanol, tetralin, isophorone, ethylene glycol monoalkyl ethers such as ethylene glycol monobutyl ether, diethylene glycol monoalkyl ethers such as diethylene glycol monoethyl ether, ethylene glycol monoalkyl or phenyl acetate, triethylene glycol monoalkyl ethers, propylene glycol monoalkyl ethers such as propylene glycol monobutyl ether, dialkyl malonates such as diethyl malonate, dipropylene glycol monoalkyl ethers such as dipropylene glycol monomethyl ether, and ester compounds such as acetates thereof. Among these solvents, N-methyl-2-pyrrolidone, dimethylimidazolidinone, γ-butyrolactone, ethylene glycol monobutyl ether, diethylene glycol monoethyl ether, propylene glycol monobutyl ether, dipropylene glycol monomethyl ether, propylene glycol monomethyl ether acetate, diethylene glycol methyl ethyl ether or methyl 3-methoxypropionate can be used particularly preferably.

One type of solvent may be used or two or more types may be used as a mixture. In addition, solvent is preferably used by adding such that the concentration of components other than solvent in the ink-jet ink is approximately 2 to approximately 100% by weight.

2.7 Radical Polymerizable Monomer

The ink-jet ink of the invention may further contain a radical polymerizable monomer. There are no particular limitations on the radical polymerizable monomer used in the invention provided it is a compound that has a radical polymerizable double bond. The number of radical polymerizable double bonds in a molecule thereof may be one or two or more.

Specific examples of radical polymerizable monomers in which the number of radical polymerizable double bonds in a molecule thereof is one include (meth)acrylic acid, crotonic acid, α-chloroacrylic acid, cinnamic acid, maleic acid, fumaric acid, itaconic acid, citraconic acid, mesaconic acid, ω-carboxypolycaprolactone mono(meth)acrylate, mono[2-(meth)acryloyloxyethyl]succinate, mono[2-(meth)acryloyloxyethyl]maleate, mono[2-(meth)acryloyloxyethyl]cyclohexene-3,4-dicarboxylate, glycidyl(meth)acrylate, methyl glycidyl(meth)acrylate, 3,4-oxirane cyclohexyl methyl(meth)acrylate, 3-methyl-3-(meth)acryloxy methyl oxetane, 3-ethyl-3-(meth)acryloxy methyl oxetane, 3-methyl-3-(meth)acryloxy ethyl oxetane, 3-ethyl-3-(meth)acryloxy ethyl oxetane, styrene, methyl styrene, vinyl toluene, chloromethyl styrene, (meth)acrylamide, tricyclo[5.2.1.0^{2,6}]decanyl(meth)acrylate, dicyclopentenyl(meth)acrylate, dicyclopentenyloxyethyl(meth)acrylate, benzyl(meth)acrylate, isobomyl(meth)acrylate, methyl(meth)acrylate, cyclohexyl(meth)acrylate, butyl(meth)acrylate, 2-hydroxyethyl(meth)acrylate, 2-hydroxypropyl(meth)acrylate, phenyl(meth)acrylate, glycerol mono(meth)acrylate, N-phenyl maleimide, polystyrene macromonomer, polymethyl methacrylate macromonomer, N-acryloyl morpholine, indene, 4-hydroxybutyl(meth)acrylate, 4-hydroxybutyl(meth)acrylate glycidyl ether and 1,4-cyclohexane dimethanol mono(meth)acrylate.

Specific examples of radical polymerizable monomers in which the number of radical polymerizable double bonds in a molecule thereof is two or more include ethylene glycol di(meth)acrylate, diethylene glycol di(meth)acrylate, methoxydiethylene glycol(meth)acrylate, methoxypolyethylene glycol(meth)acrylate, triethylene glycol di(meth)acrylate, methoxytriethylene glycol(meth)acrylate, tetraethylene glycol di(meth)acrylate, polyethylene glycol di(meth)acrylate, nonylphenoxyethylene glycol(meth)acrylate, nonylphenoxypolyethylene glycol(meth)acrylate, epichlorhydrin-modified ethylene glycol di(meth)acrylate, epichlorhydrin-modified diethylene glycol di(meth)acrylate, epichlorhydrin-modified triethylene glycol di(meth)acrylate, epichlorhydrin-modified tetraethylene glycol di(meth)acrylate, epichlorhydrin-modified polyethylene glycol di(meth)acrylate, propylene glycol di(meth)acrylate, dipropylene glycol di(meth)acrylate, methoxydipropylene glycol(meth)acrylate, tripropylene glycol di(meth)acrylate, tetrapropylene glycol di(meth)acrylate, polypropylene glycol di(meth)acrylate, nonylphenoxypolypropylene glycol di(meth)acrylate, epichlorhydrin-modified propylene glycol di(meth)acrylate, epichlorhydrin-modified dipropylene glycol di(meth)acrylate, epichlorhydrin-modified tripropylene glycol di(meth)acrylate, epichlorhydrin-modified tetrapropylene glycol di(meth)acrylate, epichlorhydrin-modified polypropylene glycol di(meth)acrylate, trimethylolpropane tri(meth)acrylate, ethylene oxide-modified trimethylolpropane tri(meth)acrylate, propylene oxide-modified trimethylolpropane tri(meth)acrylate, epichlorhydrin-modified trimethylolpropane tri(meth)acrylate, ethoxylated trimethylolpropane tri(meth)acrylate, propoxylated trimethylolpropane tri(meth)acrylate, ditrimethylolpropane tetra(meth)acrylate, tetramethylolpropane tetra(meth)acrylate, tetramethylolmethane tri(meth)acrylate, tetramethylolmethane tetra(meth)acrylate, glycerol acrylate methacrylate, glycerol di(meth)acrylate, glycerol tri(meth)acrylate, epichlorhydrin-modified glycerol tri(meth)acrylate, 1,6-hexanediol di(meth)acrylate, epichlorhydrin-modified 1,6-hexanediol di(meth)acrylate, methoxylated cyclohexyl di(meth)acrylate, neopentyl glycol di(meth)acrylate, hydroxypivalic acid neopentyl glycol di(meth)acrylate, caprolactone-modified hydroxypivalic acid neopentyl glycol di(meth)acrylate, diglycerin tetra(meth)acrylate, pentaerythritol di(meth)acrylate, pentaerythritol tri(meth)acrylate, pentaerythritol tetra(meth)acrylate, ethoxylated pentaerythritol tetra(meth)acrylate, propoxylated pentaerythritol tetra(meth)acrylate, stearic acid-modified pentaerythritol di(meth)acrylate, dipentaerythritol penta(meth)acrylate, alkyl-modified dipentaerythritol penta(meth)acrylate, alkyl-modified dipentaerythritol tetra(meth)acrylate, alkyl-modified dipentaerythritol tri(meth)acrylate, dipentaerythritol hexa(meth)acrylate, caprolactone-modified dipentaerythritol hexa(meth)acrylate, dipentaerythritol poly(meth)acrylate, allylated cyclohexyl di(meth)acrylate, bis[(meth)acryloxyneopentyl glycol]adipate, bisphenol A di(meth)acrylate, ethylene oxide-modified bisphenol A di(meth)acrylate, bisphenol F di(meth)acrylate, ethylene oxide-modified bisphenol F di(meth)acrylate, bisphenol S di(meth)acrylate, ethylene oxide-modified bisphenol S di(meth)acrylate, 1,4-butanediol di(meth)acrylate, 3-methyl-1,5-pentandiol di(meth)acrylate, 1,9-nonanediol di(meth)acrylate, 2,4-diethyl-1,5-pentanediol di(meth)acrylate, 1,3-butylene glycol(meth)acrylate, dicyclopentanyl diacrylate, ethylene oxide-modified phosphoric acid di(meth)acrylate, ethylene oxide-modified phosphoric acid tri(meth)acrylate, caprolactone/ethylene oxide-modified phosphoric acid di(meth)acrylate, caprolactone/ethylene oxide-modified phosphoric acid tri(meth)acrylate, epichlorhydrin-modified phthalic acid di(meth)acrylate, tetrabromobisphenol A di(meth)acrylate, triglycerol di(meth)acrylate, neopentyl glycerol-modified trimethylolpropane di(meth)acrylate, tris[(meth)acryloxyethyl]isocyanurate, caprolactone-modified tris[(meth)acryloxyethyl]isocyanurate, (meth)acrylated isocyanurate, urethane(meth)acrylate, 2-hydroxy-1,3-dimethacryloxypropane, 2,2-bis[4-(methacryloxyethoxy)phenyl]propane, 2,2-bis[4-(methacryloxy.diethoxy)phenyl]propane, 2,2-bis[4-(methacryloxy.polyethoxy)phenyl]propane, 2,2-bis[4-(acryloxy.diethoxy)phenyl]propane, 2,2-bis[4-(acryloxy.polyethoxy)phenyl]propane, 2-hydroxy-1-acryloxy-3-methacryloxypropane, 1,4-cyclohexane dimethanol di(meth)acrylate, tricyclodecane dimethanol di(meth)acrylate, 2,2-hydrogenated bis[4-(acryloxy.polyethoxy)phenyl]propane, 2,2-bis[4-(acryloxy-polypropoxy)phenyl]propane, tri(ethaneacrylate) isocyanurate, triallyl isocyanurate, 1,3,5-triacryloylhexahydro-s-triazine, triallyl-1,3,5-benzene carboxylate, triallylamine, triallyl citrate, triallyl phosphate, allobarbital, diallylamine, diallyldimethylsilane, diallyldisulfide, diallyl ether, diallyl isophthalate, diallyl terephthalate, 1,3-dialloxy-2-propanol, diallyl sulfide diallyl maleate, 4,4′-isopropylidene diphenol di(meth)acrylate and 4,4′-isopropylidene diphenol di(meth)acrylate.

Moreover, the radical polymerizable monomer may also be a urethane(meth)acrylate having 2 to 20 (meth)acryloyl groups. Examples of urethane(meth)acrylates having 2 to 20 (meth)acryloyl groups include NK Oligo, U-2HA, U-4HA, U-6HA, U-15-HA, U-4H and U-6H (all trademarks) manufactured by Shin-Nakamura Chemical Co., Ltd.

These radical polymerizable monomers may be used alone or two or more types may be used as a mixture.

Since addition of radical polymerizable monomer enhances the heat resistance of a coated film obtained from an ink-jet ink, the concentration of radical polymerizable monomer in the ink-jet ink of the invention is preferably approximately 0.1 to approximately 90% by weight and more preferably approximately 0.2 to approximately 80% by weight.

2.8 Photopolymerization Initiator

The ink-jet ink of the invention may further contain a photopolymerization initiator. There are no particular limitations on the photopolymerization initiator used in the invention provided it can initiate a polymerization reaction of a radical polymerizable monomer by irradiation with ultraviolet light.

Examples of photopolymerization initiators used in the invention include benzophenone, Michler's ketone, 4,4′-bis(diethylamino)benzophenone, xanthone, thioxanthone, isopropylxanthone, 2,4-diethylthioxanthone, 2-ethylanthroquinone, acetophenone, 2-hydroxy-2-methylpropiophenone, 2-hydroxy-2-methyl-4′-isopropyl propiophenone, 1-hydroxycyclohexyl phenyl ketone, isopropyl benzoin ether, isobutyl benzoin ether, 2,2-diethoxyacetophenone, 2,2-dimethoxy-2-phenylacetophenone, camphorquinone, benzanthrone, 2-methyl-1-[4-(methylthio)phenyl]-2-morpholinopropan-1-one, ethyl 2-benzyl-2-dimethylamino-1-(4-morpholinophenyl)-butanone-1,4-dimethylaminobenzoate, isoamyl 4-dimethylaminobenzoate, 4,4′-di(t-butylperoxycarbonyl)benzophenone, 3,4,4′-tri(t-butylperoxycarbonyl)benzophenone, 2,4,6,-trimethylbenzoyl diphenylphosphine oxide, 2-(4′-methoxystyryl)-4,6-bis(trichloromethyl)-s-triazine, 2-(3′,4′-dimethoxystyryl)-4,6-bis(trichloromethyl)-s-triazine, 2-(2′,4′-dimethoxystyryl)-4,6-bis(trichloromethyl)-s-triazine, 2-(2′-methoxystyryl)4,6-bis(trichloromethyl)-s-triazine, 2-(4′-pentyloxystyryl)-4,6-bis(trichloromethyl)-s-triazine, 4-[p-N,N-di(ethoxycarbonylmethyl)]-2,6-di(trichloromethyl)-s-triazine, 1,3-bis(trichloromethyl)-5-(2′-chlorophenyl)-s-triazine, 1,3-bis(trichloromethyl)-5-(4′-methoxy phenyl)-s-triazine, 2-(p-dimethylaminostyryl)benzoxazole, 2-(p-dimethylaminostyryl)benzthiazole, 2-mercaptobenzothiazole, 3,3′-carbonylbis(7-diethylaminocoumarin), 2-(o-chlorophenyl)-4,4′,5,5′-tetraphenyl-1,2′-biimidazole, 2,2′-bis(2-chlorophenyl)-4,4′,5,5′-tetraquis(4-ethoxycarbonylphenyl)-1,2′-biimidazole, 2,2′-bis(2,4-dichlorohenyl)4,4′,5,5′-tetraphenyl-1,2′-biimidazole, 2,2′-bis(2,4-dibromophenyl)4,4′,5,5′-tetraphenyl-1,2′-biimidazole, 2,2′-bis(2,4,6-trichlorophenyl)-4,4′,5,5′-tetraphenyl-1,2′-biimidazole, 3-(2-methyl-2-dimethylaminopropionyl)carbazole, 3,6-bis(2-methyl-2-morpholinopropionyl)-9-n-dodecylcarbazole, 1-hydroxycyclohexyl phenyl ketone, bis(η⁵-2,4-cyclopentadien-1-yl)-bis(2,6-difluoro-3-(1H-pyrrol-1-yl)-phenyl)titanium, compound represented by the following general formula (2), 2-methyl-1-[4-(methylthio)phenyl]-2-morpholinopropan-1-one and 2-benzyl-2-dimethylaminol-(4-morpholinophenyl)-butanone-1,1,2-octanedione-1-[4-(phenylthio)phenyl]-2-(O-benzoyloxime). These photopolymerization initiators may be used alone or two or more types may be used as a mixture.

Among these, if the photopolymerization initiator is one or more selected from a compound represented by the following general formula (9), 1,2-octanedione-1-[4-(phenylthio)phenyl]-2-(O-benzoyloxime), 2-methyl-1-[4-(methylthio)phenyl]-2-morpholinopropan-1-one or 2-benzyl-2-dimethylamino-1-(4-morpholinophenyl)-butanone-1, sensitivity is high thereby making this preferable.

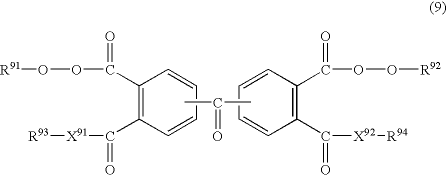

wherein, R⁹¹, R⁹², R⁹³ and R⁹⁴ respectively and independently represent an alkyl having 1 to 13 carbon atoms, and X⁹¹ and X⁹² respectively and independently represent —O—, —O—O— or —NH—.

Examples of compounds represented by general formula (9) include 3,3′4,4′-tetra(t-butylperoxycarbonyl)benzophenone, 3,3′4,4′-tetra(t-hexylperoxycarbonyl)benzophenone, 3,3′-di(methoxycarbonyl)-4,4′-di(t-butylperoxycarbonyl)benzophenone, 3,4′-di(methoxycarbonyl)-4,3′-di(t-butylperoxycarbonyl)benzophenone and 4,4′-di(methoxycarbonyl)-3,3′-di(t-butylperoxycarbonyl)benzophenone.

These photopolymerization initiators may be used alone or two or more types may be used as a mixture.

An ink-jet ink containing both a photopolymerization initiator and a radical polymerizable monomer allows the obtaining of a cured film when irradiated with ultraviolet light, thereby simplifying the process and making this preferable.

The concentration of photopolymerization initiator in the ink-jet ink of the invention is preferably approximately 0.01 to approximately 10% by weight and more preferably approximately 0.02 to approximately 5% by weight.

2.9 Additives Added to Ink-jet Ink of the Invention

The ink-jet ink of the invention contains a fluorine-containing compound (C) or a copolymer (C′), depending on the target characteristics, the ink-jet ink of the invention can also be obtained by selecting and adding a surfactant, antistatic agent, coupling agent, epoxy curing agent, aminosilicon compound, solvent or other additives as necessary followed by the uniform mixing and dissolving thereof in the ink-jet ink of the invention.

(1) Surfactant

When desiring to improve coatability, for example, a surfactant can be added corresponding to that objective. Specific examples of surfactants added to the ink-jet ink of the invention include silicon-based surfactants such as product names “Byk-300”, “Byk-306”, “Byk-335”, “Byk-310”, “Byk-341”, “Byk-344” or “Byk-370” (all manufactured by BYK Additives and Instruments Ltd.), acrylic-based surfactants such as product names “Byk-354”, “Byk-358” or “Byk-361” (all manufactured by BYK Additives and Instruments Ltd.), and fluorine-based surfactants such as product names “DFX-18”, “Ftergent 250” or “Ftergent 251” (all manufactured by Neos Co., Ltd.).

One type of these surfactants may be used or two or more types may be used as a mixture.

Surfactants are used to improve wettability to an underlying substrate, flatness or coatability, and are preferably used by adding approximately 0.01 to approximately 1% by weight to an ink-jet ink.

(2) Antistatic Agent

There are no particular limitations on antistatic agents able to be added to the ink-jet ink of the invention, and ordinary antistatic agents can be used, specific examples of which include metal oxides such as tin oxide, tin oxide-antimony oxide compound oxide or tin oxide-indium oxide compound oxide, and quaternary ammonium salts.

One type of these antistatic agents may be used or two or more types may be used as a mixture.

Antistatic agents are used to prevent static charge, and are preferably used by adding approximately 0.01 to approximately 1% by weight to ink-jet ink.

(3) Coupling Agent

There are no particular limitations on coupling agents able to be added to the ink-jet ink of the invention, and ordinary coupling agents can be used. The coupling agent added is preferably a silane coupling agent, specific examples of which include trialkoxysilane compounds and dialkoxysilane compounds. Preferable examples include γ-vinylpropyl trimethoxysilane, γ-vinylpropyl triethoxysilane, γ-acryloylpropylmethyl dimethoxysilane, γ-acryloylpropyl trimethoxysilane, γ-acryloylpropylmethyl diethoxysilane, γ-acryloylpropyl triethoxysilane, γ-methacryloylpropylmethyl dimethoxysilane, γ-methacryloylpropyl trimethoxysilane, γ-methacryloylpropylmethyl ethoxysilane, γ-methacryloylpropyl triethoxysilane, γ-glycidoxypropylmethyl dimethoxysilane, γ-glycidoxypropyl trimethoxysilane, γ-glycidoxypropylmethyl diethoxysilane, γ-glycidoxypropyl triethoxysilane, γ-aminopropylmethyl dimethoxysilane, γ-aminopropyl trimethoxysilane, γ-amninopropylmethyl dimethoxysilane, γ-aninopropyl triethoxysilane, N-aminoethyl-γ-iminopropylmethyl dimethoxysilane, N-amninoethyl-γ-aminopropyl trimethoxysilane, N-aminoethyl-γ-aminopropyl diethoxysilane, N-phenyl-γ-aminopropyl trimethoxysilane, N-phenyl-γ-aminopropyl triethoxysilane, N-phenyl-γ-aminopropylmethyl dimethoxysilane, N-phenyl-γ-aminopropylmethyl diethoxysilane, γ-mercaptopropylmethyl dimethoxysilane, γ-aminopropyl trimethoxysilane, γ-mercaptopropylmethyl diethoxysilane, γ-mercaptopropyl triethoxysilane, γ-isocyanurate propylmethyl diethoxysilane and γ-isocyanurate propyl triethoxysilane. In particular, examples include γ-vinylpropyl trimethoxysilane, γ-acryloylpropyl trimethoxysilane, γ-methacryloylpropyl trimethoxysilane and γ-isocyanurate propyl triethoxysilane.

One type of these coupling agents may be used or two or more types may be used as a mixture.

Coupling agents are.preferably used by adding approximately 0.01 to approximately 3% by weight to ink-jet ink.

(4) Epoxy Curing Agent

There are no particular limitations on epoxy curing agents able to be added to the ink-jet ink of the invention, and ordinary epoxy curing agents can be used, specific examples of which include organic acid dihydrazide compounds, imidazoles and derivatives thereof, dicyandiamides, aromatic amines, polyvalent carboxylic acids and polyvalent carboxylic acid anhydrides. More specifically, examples include dicyandiamides such as dicyandiamide, organic acid dihydrazides such as adipic acid dihydrazide or 1,3-bis(hydrazinocarboethyl)-5-isopropyl hydantoin, imidazole derivatives such as 2,4-diamino-6-[2′-ethylimidazolyl-(1′)]-ethyl triazine, 2-phenylimidazole, 2-phenyl-4-methylimidazole or 2-phenyl-4-methyl-5-hydroxymethylimidazole, and acid anhydrides such as phthalic anhydride, trimellitic anhydride or 1,2,4-cyclohexane tricarboxylic-1,2-anhydride. Among these, trimellitic anhydride and 1,2,4-cyclohexane tricarboxylic-1,2-anhydride are preferable because of their favorable transparency.

One type of these epoxy curing agents may be used or two or more types may be used as a mixture.

Epoxy curing agents are preferably used by adding approximately 0.2 to approximately 5% by weight to ink-jet ink.

(5) Aminosilicon Compound

An aminosilicon compound can be added to the ink-jet ink of the invention. Examples of aminosilicon compounds include para-aminophenyl trimethoxysi lane, para-aminophenyl triethoxysilane, meta-aminophenyl trimethoxysilane, meta-aminophenyl triethoxysilane, aminopropyl trimethoxysilane and aminopropyl triethoxysilane.

One type of these aminosilicon compounds may be used or two or more types may be used as a mixture.

Aminosilicon compounds are used to improve adhesion to a substrate, and are preferably used by adding approximately 0.05 to approximately 2% by weight to an ink-jet ink.

3. Coating of Ink-jet Ink by an Ink-jet Method

The ink-jet ink of the invention can be used in an ink-jet coating method having a step in which it is coated using a known ink-jet method. Examples of ink-jet coating methods include methods in which the ink is coated by allowing mechanical energy to act on the ink, and methods in which the ink is coated by allowing thermal energy to act on the ink.

The use of an ink-jet coating method allows ink-jet ink to be coated in a predetermined pattern. As a result, ink is able to be only coated at locations required to be coated, thereby reducing costs.

A preferable example of a coating unit for carrying out coating using an ink of the invention is a coating unit provided with an ink storage unit for housing these inks and a coating head. An example of a coating unit is a coating unit that allows thermal energy to act on ink corresponding to a coating signal, and then uses that energy to generate ink droplets.

An example of a coating head has a heat generation unit liquid contact surface containing a metal and/or metal oxide. Specific examples of the metal and/or metal oxide include metals such as Ta, Zr, Ti, Ni or Al and oxides thereof.

An example of a coating apparatus for carrying out coating using an ink of the invention is an apparatus in which energy corresponding to a coating signal is applied to ink in the chamber of a coating head having an ink storage unit in which ink is housed, and that energy is used to generate ink droplets.

The ink-jet coating apparatus is not limited to that in which the coating head and ink storage unit are separated, but rather that in which these two components are inseparably integrated may also be used. In addition, the ink storage unit may be separably or inseparably integrated with the coating head and loaded onto a carriage or provided at a fixed site of the apparatus, and ink may be supplied to the coating head by means of an ink supply member such as a tube.

4. Formation of Cured Film

A coated film can be formed over a desired range of a substrate surface using a known ink-jet coating method by discharging the ink-jet ink of the invention onto a base material surface such as a substrate, heating on a hot plate or in an oven, and removing the solvent. Although varying according to the type of each component and the proportions in which they are blended, heating conditions are normally a temperature of approximately 70 to approximately 120° C. for approximately 5 to approximately 15 minutes in case of using an oven or for approximately 1 to approximately 10 minutes in the case of using a hot plate to form a coated film.

After forming a coated film, the coated film is irradiated with ultraviolet light as desired followed by further heat-treating at approximately 150 to approximately 250° C. and preferably approximately 160 to approximately 230° C. for approximately 5 to approximately 30 minutes in the case of using an oven or for approximately 2 to approximately 20 minutes in the case of using a hot plate to obtain a cured film of the invention.

There are no particular limitations on the base material, and examples include plastic films including polyester-based resins such as polyethylene terephthalate (PET) or polybutylene terephthalate (PBT), polyolefin resins such as polyethylene or polypropylene, polyvinyl chloride, fluororesins, acrylic-based resins, polyamides, polycarbonates or polyimides, cellophane, acetate, metal foil, glassine paper having sealing effects or parchment paper, and paper subjected to sealing treatment with, for example, polyethylene, clay binder, polyvinyl alcohol, starch or carboxymethyl cellulose (CMC). Furthermore, materials composing these base materials may further contain additives such as pigments, dyes, antioxidants, anti-degradation agents, fillers, ultraviolet absorbers, antistatic agents and/or electromagnetic shielding agents within a range that does not have a detrimental effect on the effects of the invention.

There are no particular limitations on the above-mentioned base material, and although the thickness thereof is normally about approximately 10 μm to approximately 2 mm and is suitably adjusted according to the purpose of use, the thickness is preferably approximately 15 to approximately 500 μm and more preferably approximately 20 to approximately 200 μm.

The surface for forming a cured film on the base material may be subjected to treatment that facilitates adhesion such as coronal treatment, plasma treatment or blasting treatment as necessary, or a readily adhesive layer may be provided on that surface.

### EXAMPLES

Although the following provides a more detailed explanation of the invention through examples and comparative examples thereof, the invention is not limited to these examples.

The names of fluorine-containing compound (C), diamines, compounds having two or more acid anhydride groups and solvents used in the examples and comparative examples are indicated with abbreviations. Those abbreviations are used in the following descriptions.

Fluorine-Containing Compound (C)

Compound represented by the following formula (30) (γ-methacryloxypropyl-hepta(trifluoropropyl)-T8-silsesquioxane): F-PSQ

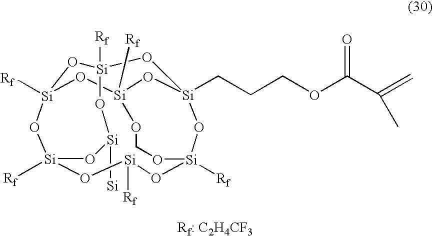

Diamines: 4,4′-diaminodiphenyl ether)APE); 3,3′-diaminodiphenylsulfone (DDS).

Compounds Having Two or More Acid Anhydride Groups: Pyromellitic dianhydride (PMDA); 3,3′,4,4′-Diphenyl ether tetracarboxylic dianhydride (ODPA).

Solvents: N-methyl-2-pyrrolidone (NMP); Diethylene glycol methyl ethyl ether (EDM).

### Synthesis Example 1

### Synthesis of Copolymer (C′)

150 g of 2-butanone were placed in a 300 mL four-mouth flask equipped with a thermometer, stirrer, raw material feed port and nitrogen gas inlet followed by heating to reflux. Moreover, the following components: 2-butanone (50.0 g); F-PSQ (10.0 g); glycidyl methacrylate (40.0 g); and 2,2′-azobis(2,4-dimethylvaleronitrile) (2.0 g) were mixed and dissolved and the resulting reagent was dropped in over the course of 2 hours followed by further refluxing for 2 hours following completion of dropping.

After cooling, the solution was added to 2 L of hexane to form a precipitate and the supematant was discarded followed by vacuum-drying for 10 hours at 40° C. The resulting dry polymer was crushed with a mixer followed by further vacuum-drying for 15 hours at 40° C. to obtain 41.3 g of a copolymer of F-PSQ and glycidyl methacrylate (to be referred to as Copolymer 1). When this copolymer was measured by GPC, the weight average molecular weight Mw thereof was 5,200 based on polyethylene oxide.

### Synthesis Example 2

### Synthesis of Compound (B)

21.81 g of PMDA, 20.02 g of APE and 400 g of dehydrated and purified NMP were placed in a 1000 mL four-mouth flask equipped with a thermometer, stirrer, raw material feed port and nitrogen gas inlet followed by stirring for 30 hours at 25° C. in the presence of flowing dry nitrogen. 394.77 g of dehydrated and purified NMP were added to this reaction solution followed by stirring for 8 hours at 60° C. to obtain a pale yellow, clear 5% by weight solution of Compound (B) (to be referred to as PA Acid Solution 1). The viscosity of this solution was 38 mPa·s (E type viscometer, 25° C.). In addition, when the resulting Compound (B) was measured by GPC, the weight average molecular weight thereof was 41,000.

### Synthesis Example 3

### Synthesis of Compound (A)

65.00 g of ODPA, 9.44 g of 1,4-butanediol and 111.66 g of dehydrated and purified NMP were placed in a 500 mL four-mouth flask equipped with a thermometer, stirrer, raw material feed port and nitrogen gas inlet followed by stirring for 1 hour at 130° C. in the presence of flowing dry nitrogen. This reaction solution was cooled to 40° C. and 26.01 g of DDS and 122.72 g of dehydrated and purified NMP were added to the cooled reaction solution followed by stirring for 2 hours at 40° C. in the presence of flowing dry nitrogen. Subsequently, 167.42 g of dehydrated and purified NMP were further added followed by stirring to obtain a pale yellow, clear 20% solution of Compound (A) (to be referred to as PE-PA Acid Solution 1). The viscosity of the resulting solution of Compound (A) was 311 mPa·s. In addition, when the resulting Compound (A) was measured by GPC, the weight average molecular weight thereof was 14,000.

### Synthesis Example 4

### Synthesis of Polymer Obtained Without Using Compound

Represented by Formula (1)

42.2 g of a copolymer of methyl methacrylate and glycidyl methacrylate (to be referred to as Copolymer 2) were obtained under the same conditions as Synthesis Example 1 with the exception of using methyl methacrylate instead of F-PSQ. The weight average molecular weight Mw of the resulting copolymer was 4,500.

### Example 1

Each of the components indicated below was mixed and dissolved at room temperature in the presence of flowing dry nitrogen: F-PSQ (1.0 g); 4-Hydroxybutylacrylate (8.0 g); Celoxide 2021P (Daicel Chemical Industries, Ltd., epoxy Resin of formula (6)) (1.0 g); and EDM (90.0 g).

A solution obtained in this manner was filtered with a 0.2 μm fluororesin membrane filter to prepare an ink-jet ink.

This ink-jet ink was injected into an ink-jet cartridge and the cartridge was installed in an ink-jet apparatus (DMP-2811 (product name), Dimatix Inc.). This was then coated onto the entire surface of a polyimide film in the form of a Kapton film (registered trademark, Du Pont-Toray Co., Ltd., thickness: 150 μm, H type) (to be referred to as a “Kapton substrate”). After drying this substrate for 5 minutes on a hot plate at 80° C., it was baked for 30 minutes in an oven at 220° C. to obtain a Kapton substrate having a cured film of the invention. When this was measured using the FE-3000 Reflective Film Thickness Monitor manufactured by Otsuka Electronics Co., Ltd., the thickness of the cured film was about 110 nm.

Next, the ink-jet cartridge installed in the ink-jet apparatus was replaced with an ink-jet cartridge injected with AG-IJ-G-100-S1 silver ink manufactured by Cabot Corp. followed by drawing a straight line. At this time, drawing conditions were set so that the line width and width between lines were the same. In subsequent descriptions, the setting of line width and space width will be abbreviated as 100 μm when, for example, drawing conditions are set so that both line width and width between lines are 100 μm.

Silver wiring was drawn by setting the discharge voltage and frequency so that film thickness on the cured film provided on the substrate was 2 μm while changing the settings for line and space widths from 100 μm to 500 μm in a stepwise manner in 20 μm increments.

After drying this substrate for 5 minutes on a hot plate at 100° C., it was baked for 30 minutes in an oven at 220° C. to obtain a Kapton substrate on which a silver wiring pattern was formed of lines and spaces. When this substrate was observed with a microscope, although there were some areas in which the spaces were smudged due to running of the liquid in the case of setting the line and space width to 100 to 140 μm, in the case of setting to 160 μm or more, lines were drawn without causing smudging of the spaces. In addition, there was no peeling of the silver wiring observed when cellophane tape (cellophane tape defined in JIS D0202-1988, CT24, Nichiban Co., Ltd.) was affixed to the substrate and peeled off rapidly all at once.

### Comparative Example 1

Drawing, drying and baking of silver wiring were carried out under the same conditions as Example 1 with the exception of using a Kapton substrate on which ink-jet ink was not coated over the entire surface thereof. When the substrate on which the silver wiring was drawn was observed with a microscope, spaces were observed to be smudged due to bleeding of liquid in the case of setting the line and space widths to 100 to 280 μm. In addition, there was no peeling of the silver wiring observed when cellophane tape (cellophane tape defined in JIS D0202-1988, CT24, Nichiban Co., Ltd.) was affixed to the substrate and peeled off rapidly all at once.

### Comparative Example 2

Each of the components indicated below was mixed and dissolved at room temperature in the presence of flowing dry nitrogen: DFX-18 fluorine-based surfactant (Neos Co., Ltd.) (1.0 g); 4-Hydroxybutylacrylate (8.0 g); Celoxide 2021P (Daicel Chemical Industries, Ltd., epoxy Resin of formula (6)) (1.0 g); and EDM (90.0 g).

A solution obtained in this manner was filtered with a 0.2 μm fluororesin membrane filter to prepare an ink-jet ink.

An ink-jet ink was coated onto a Kapton substrate under the same conditions as Example 1 with the exception of using this ink-jet ink to obtain a Kapton substrate having a cured film having a thickness of about 95 nm.

Silver wiring was drawn, dried and baked under the same conditions as Example 1 using this Kapton substrate. When this substrate was observed with a microscope, although spaces were smudged due to bleeding of liquid in the case line and space widths were set to 100 to 140 μm, in the case of setting the widths to 160 μm or more, the silver wiring was able to be drawn without smudging the spaces. However, the majority of the silver wiring ended up peeling off when cellophane tape (cellophane tape defined in JIS D0202-1988, CT24, Nichiban Co., Ltd.) was affixed to the substrate and then peeled off rapidly all at once.

### Example 2

Each of the components indicated below was mixed and dissolved at room temperature in the presence of flowing dry nitrogen: Copolymer 1 (9.0 g); Trimellitic acid (1.0 g); and EDM (90.0 g).

A solution obtained in this manner was filtered with a 0.2 μm fluororesin membrane filter to prepare an ink-jet ink.

This ink-jet ink was used to coat onto the entire surface of a Kapton substrate under the same conditions as Example 1 to obtain a Kapton substrate having a cured film having a thickness of about 125 nm.

Silver wiring was drawn, dried and baked under the same conditions as Example 1 using this Kapton substrate. When this substrate was observed with a microscope, the silver wiring was observed to be drawn without causing smudging of the spaces even in the case of setting the line and space widths to 140 μm. In addition, there was no peeling of the silver wiring observed when cellophane tape (cellophane tape defined in JIS D0202-1988, CT24, Nichiban Co., Ltd.) was affixed to the substrate and then peeled off rapidly all at once.

### Example 3

Each of the components indicated below was mixed and dissolved at room temperature in the presence of flowing dry nitrogen: Copolymer 1 (6.0 g); PA Acid Solution 1 (40.0 g); and NMP (54.0 g).

A solution obtained in this manner was filtered with a 0.2 μm fluororesin membrane filter to prepare an ink-jet ink.

This ink-jet ink was used to coat onto the entire surface of a Kapton substrate under the same conditions as Example 1 to obtain a Kapton substrate having a cured film having a thickness of about 100 nm.

Silver wiring was drawn, dried and baked under the same conditions as Example 1 using this Kapton substrate. When this substrate was observed with a microscope, the silver wiring was observed to be drawn without causing smudging of the spaces even in the case of setting the line and space widths to 140 μm. In addition, there was no peeling of the silver wiring observed when cellophane tape (cellophane tape defined in JIS D0202-1988, CT24, Nichiban Co., Ltd.) was affixed to the substrate and then peeled off rapidly all at once.

### Example 4

Each of the components indicated below was mixed and dissolved at room temperature in the presence of flowing dry nitrogen: Copolymer 1 (6.0 g); PE-PA Acid Solution 1 (10.0 g); and NMP (84.0 g).

A solution obtained in this manner was filtered with a 0.2 μm fluororesin membrane filter to prepare an ink-jet ink.

This ink-jet ink was used to coat onto the entire surface of a Kapton substrate under the same conditions as Example 1 to obtain a Kapton substrate having a cured film having a thickness of about 75 nm.

Silver wiring was drawn, dried and baked under the same conditions as Example 1 using this Kapton substrate. When this substrate was observed with a microscope, the silver wiring was observed to be drawn without causing smudging of the spaces even in the case of setting the line and space widths to 160 μm. In addition, there was no peeling of the silver wiring observed when cellophane tape (cellophane tape defined in JIS D0202-1988, CT24, Nichiban Co., Ltd.) was affixed to the substrate and then peeled off rapidly all at once.

### Comparative Example 3

Each of the components indicated below was mixed and dissolved at room temperature in the presence of flowing dry nitrogen: Copolymer 2 (6.0 g); PE-PA Acid Solution 1 (10.0 g); and NMP (84.0 g).

A solution obtained in this manner was filtered with a 0.2 μm fluororesin membrane filter to prepare an ink-jet ink.

This ink-jet ink was used to coat onto the entire surface of a Kapton substrate under the same conditions as Example 1 to obtain a Kapton substrate having a cured film having a thickness of about 80 nm.

Silver wiring was drawn, dried and baked under the same conditions as Example 1 using this Kapton substrate. When this substrate was observed with a microscope, spaces were observed to be smudged due to bleeding of liquid even in the case line and space widths were set to 220 μm. In addition, there was no peeling of the silver wiring observed when cellophane tape (cellophane tape defined in JIS D0202-1988, CT24, Nichiban Co., Ltd.) was affixed to the substrate and then peeled off rapidly all at once.

### INDUSTRIAL APPLICABILITY

The ink-jet ink of the invention can be used, for example, to modify the surface of an insulating polyimide film used in an electronic circuit substrate.

Although the invention has been described and illustrated with a certain degree of particularity, it is understood that the disclosure has been made only by way of example, and that numerous changes in the conditions and order of steps can be resorted to by those skilled in the art without departing from the spirit and scope of the invention.

What is claimed is:

1. An ink-jet ink comprising a fluorine-containing compound (C) in the form of fluorosilsesquioxane having an organic group having 1 to 100 carbon atoms.

2. An ink-jet ink comprising a fluorine-containing compound (C) represented by formula (3): 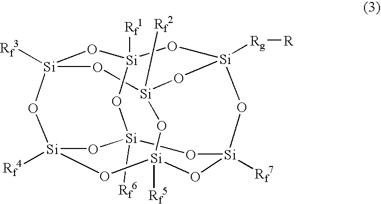
wherein, R_{g} represents a single bond or an alkylene having 1 to 20 carbon atoms in which an arbitrary methylene may be replaced by oxygen; R_{f}¹ to R_{f}⁷ respectively and independently represent a linear or branched fluoroalkyl having 1 to 20 carbon atoms in which an arbitrary methylene may be replaced by oxygen, a fluoroaryl having 6 to 20 carbon atoms in which one or more hydrogens are replaced by fluorine or —CF₃, a fluoroarylalkyl having 7 to 20 carbon atoms in which one or more hydrogens in the aryl are replaced by fluorine or —CF₃, a linear or branched alkyl having 1 to 20 carbon atoms and not containing fluorine in which an arbitrary methylene may be replaced by oxygen, an aryl having 6 to 20 carbon atoms and not containing fluorine or an arylalkyl having 7 to 20 carbon atoms and not containing fluorine, and at least one of R_{f}¹ to R_{f}⁷ is a fluoroalkyl, fluoroaryl or fluoroarylaklyl; and, R represents hydrogen or an organic group having 1 to 100 carbon atoms.

3. The ink-jet ink according to claim 2, wherein R is an organic group having 2 to 100 carbon atoms and a thermal crosslinking functional group or an organic group having 2 to 100 carbon atoms and a double bond.

4. The ink-jet ink according to claim 3, wherein the thermal crosslinking functional group is a hydroxy, oxirane, oxetane, carboxy, isocyanate, amino or acid anhydride.

5. The ink-jet ink according to claim 3, wherein the organic group having 2 to 100 carbon atoms and a double bond has an acryloyl, methacryloyl, styryl, vinyl or maleimido.

6. The ink-jet ink according to claim 2, wherein R_{f}¹ to R_{f}⁷ respectively and independently are a 2,2,2-trifluoroethyl, 3,3,3-trifluoropropyl, 2,2,3,3-tetrafluoropropyl, 2,2,3,3,3-pentafluoropropyl, 3,3,4,4,4-pentafluorobutyl or 3,3,4,4,5,5,6,6,6-nonafluorohexyl.

7. The ink-jet ink according to claim 2, wherein R_{g} is an ethylene, propylene or butylene.

8. An ink-jet ink comprising a copolymer (C′) of a fluorine-containing compound (C) in the form of fluorosilsesquioxane having an organic group having 1 to 100 carbon atoms, and at least one other radical polymerizable monomer.

9. An ink-jet ink comprising a copolymer (C′) of a fluorine-containing compound (C) represented by formula (3): 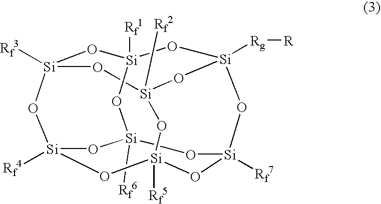
wherein, R_{g} represents a single bond or an alkylene having 1 to 20 carbon atoms in which an arbitrary methylene may be replaced by oxygen; R_{f}¹ to R_{f}⁷ respectively and independently represent a linear or branched fluoroalkyl having 1 to 20 carbon atoms in which an arbitrary methylene may be replaced by oxygen, a fluoroaryl having 6 to 20 carbon atoms in which one or more hydrogens are replaced by fluorine or —CF₃, a fluoroarylalkyl having 7 to 20 carbon atoms in which one or more hydrogens in the aryl are replaced by fluorine or —CF₃, a linear or branched alkyl having 1 to 20 carbon atoms and not containing fluorine in which an arbitrary methylene may be replaced by oxygen, an aryl having 6 to 20 carbon atoms and not containing fluorine or an arylalkyl having 7 to 20 carbon atoms and not containing fluorine, and at least one of R_{f}¹ to R_{f}⁷ is a fluoroalkyl, fluoroaryl or fluoroarylaklyl; and, R represents an organic group having 2 to 100 carbon atoms and an acryloyl, methacryloyl, styryl, vinyl or maleimido), and at least one other radical polymerizable monomer.

10. The ink-jet ink according to claim 9, wherein R_{f}¹ to R_{f}⁷ respectively and independently are a 2,2,2-trifluoroethyl, 3,3,3-trifluoropropyl, 2,2,3,3-tetrafluoropropyl, 2,2,3,3,3-pentafluoropropyl, 3,3,4,4,4-pentafluorobutyl or 3,3,4,4,5,5,6,6,6-nonafluorohexyl.

11. The ink-jet ink according to claim 9, wherein R_{g} is an ethylene, propylene or butylene.

12. The ink-jet ink according to claim 8, wherein the at least one other radical polymerizable monomer has a thermal crosslinking functional group.

13. The ink-jet ink according to claim 12, wherein the thermal crosslinking functional group of the at least one other radical polymerizable monomer is at least one of a hydroxy, oxirane, oxetane, carboxy, isocyanate, amino and acid anhydride.

14. The ink-jet ink according to claim 8, wherein the at least one other radical polymerizable monomer is at least one monomer selected from the group of glycidyl(meth)acrylate, 3,4-epoxycyclohexyl(meth)acrylate, methylglycidyl(meth)acrylate, (3-ethyl-3-oxetanyl)methyl(meth)acrylate, 2-hydroxyethyl(meth)acrylate, 2-hydroxypropyl(meth)acrylate, 4-hydroxybutyl(meth)acrylate, 4-hydroxybutyl(meth)acrylate glycidyl ether and 1,4-cyclohexane dimethanol mono(meth)acrylate.

15. The ink-jet ink according to claim 1 further comprising a compound (B) having a structural unit represented by the following general formula (2): 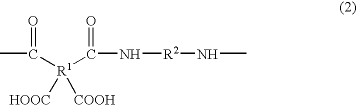
wherein, R¹ and R² respectively and independently represent an organic group having 2 to 100 carbon atoms.

16. The ink-jet ink according to claim 15, wherein compound (B) is synthesized using at least a diamine (b1) and a compound (b2) having two or more acid anhydride groups.

17. The ink-jet ink according to claim 16, wherein diamine (b1) is one or more groups selected from the group of 4,4′-diaminodiphenylsulfone, 3,3′-diaminodiphenylsulfone, 3,4′-diaminodiphenylsulfone, bis[4-(4-aminophenoxy)phenyl]sulfone, bis[4-(3-aminophenoxy)phenyl]sulfone, bis[3-(4-aminophenoxy)phenyl]sulfone, [4-(4-aminophenoxy)phenyl] [3-(4-aminophenoxy)phenyl]sulfone, [4-(3-aminophenoxy)phenyl][3-(4-aminophenoxy)phenyl]sulfone, 4,4′-diaminodiphenyl ether, 4,4′-diaminodiphenyl methane, 3,3′-diaminodiphenyl methane, 3,3′-dimethyl-4,4′-diaminodiphenyl methane, 2,2-bis[4-(4-aminophenoxy)phenyl]propane, 2,2-bis[4-(4-aminophenoxy)phenyl]hexafluoropropane and a compound represented by formula (4): 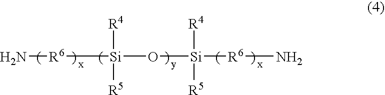
wherein, R⁴ and R⁵ independently represent an alkyl having 1 to 3 carbon atoms or phenyl, R⁶ independently represents a methylene, phenylene or alkyl-substituted phenylene, x independently represents an integer of 1 to 6, and y represents an integer of 1 to 10; and,compound (b2) having two or more acid anhydride groups is one or more groups selected from the group of pyromellitic acid dianhydride, 1,2,3,4-cyclobutane tetracarboxylic acid dianhydride, 1,2,3,4-butane tetracarboxylic acid dianhydride, 1,2,4,5-cyclohexane tetracarboxylic acid dianhydride, 3,3′,4,4′-diphenylether tetracarboxylic acid dianhydride and 3,3′,4,4′-diphenylsulfone tetracarboxylic acid dianhydride.

18. The ink-jet ink according to claim 15 comprising approximately 0.1 to approximately 50% by weight of fluorine-containing compound (C) or copolymer (C′) of fluorine-containing compound (C) and other radical polymerizable monomer, and approximately 0.1 to approximately 50% by weight of compound (B).

19. The ink-jet ink according to claim 1 further comprising a compound (A) having structural units represented by the following general formulas (1) and (2): 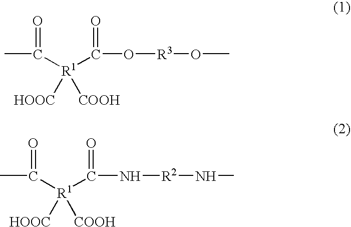
wherein, R¹, R² and R³ respectively and independently represent an organic group having 2 to 100 carbon atoms.

20. The ink-jet ink according to claim 19, wherein compound (A) is synthesized using at least a polyvalent hydroxy compound (a1), a diamine (a2) and a compound (a3) having two or more acid anhydride groups.

21. The ink-jet ink according to claim 20, wherein compound (a3) having two or more acid anhydride groups is one or more compounds selected from the group of a tetracarboxylic acid dianhydride and a copolymer of a polymerizable monomer having an acid anhydride group and other polymerizable monomer.

22. The ink-jet ink according to claim 21, wherein the copolymer of a polymerizable monomer having an acid anhydride group and other polymerizable monomer is a styrene-maleic anhydride copolymer.

23. The ink-jet ink according to claim 20, wherein polyvalent hydroxy compound (a1) is at least one compound selected from the group of ethylene glycol, diethylene glycol, triethylene glycol, tetraethylene glycol, propylene glycol, dipropylene glycol, tripropylene glycol, tetrapropylene glycol, 1,4-butanediol, 1,5-pentanediol, 1,6-hexanediol, glycerin, trimethylolpropane, pentaerythritol and dipentaerythritol; diamine (a2) is at least one diamine selected from the group of 4′-diaminodiphenylsulfone, 3,3′-diaminodiphenylsulfone, 3,4′-diaminodiphenylsulfone, bis[4-(4-aminophenoxy)phenyl]sulfone, bis[4-(3-aminophenoxy)phenyl]sulfone, bis[3-(4-aminophenoxy)phenyl]sulfone, [4-(4-aminophenoxy)phenyl][3-(4-aminophenoxy)phenyl]sulfone, [4-(3-aminophenoxy)phenyl][3-(4-aminophenoxy)phenyl]sulfone, 4,4′-diaminodiphenylether, 4,4′-diaminodiphenylmethane, 3,3′-diaminodiphenylmethane, 3,3′-dimethyl-4,4′-diaminodiphenyl methane, 2,2-bis[4-(4-aminophenoxy)phenyl]propane, 2,2-bis[4-(4-aminophenoxy)phenyl]hexafluoropropane and a compound represented by formula (4): 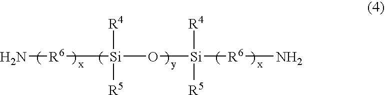
wherein, R⁴ and R⁵ independently represent an alkyl having 1 to 3 carbon atoms or phenyl, R⁶ independently represent a methylene, phenylene or alkyl-substituted phenylene, x independently represents an integer of 1 to 6, and y represents an integer of 1 to 10; and, compound (a3) having two or more acid anhydride groups is one or more compounds selected from the group of styrene-maleic anhydride copolymer, pyromellitic acid dianhydride, 1,2,3,4-cyclobutane tetracarboxylic acid dianhydride, 1,2,3,4-butane tetracarboxylic acid dianhydride, 1,2,4,5-cyclohexane tetracarboxylic acid dianhydride, 3,3′,4,4′-diphenylether tetracarboxylic acid dianhydride and 3,3′,4,4′-diphenylsulfone tetracarboxylic acid dianhydride.

24. The ink-jet ink according to claim 20, wherein polyvalent hydroxy compound (a1) is one or more compounds selected from the group of 1,4-butanediol, 1,5-pentanediol and 1,6-hexanediol; diamine (a2) is one or more diamines selected from the group of 3,3′-diaminodiphenylsulfone, 4,4′-diaminodiphenyl ether, 4,4′-diaminodiphenylmethane and a compound represented by formula (4): 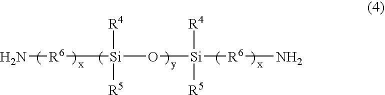
wherein, R⁴ and R⁵ independently represent an alkyl having 1 to 3 carbon atoms or phenyl, R⁶ independently represent a methylene, phenylene or alkyl-substituted phenylene, x independently represents an integer of 1 to 6, and y represents an integer of 1 to 10; and, compound (a3) having two or more acid anhydride groups is one or more compounds selected from the group of pyromellitic acid, styrene-maleic anhydride copolymer, 3,3′,4,4′-diphenylether tetracarboxylic acid dianhydride, 3,3′,4,4′-diphenylsulfone tetracarboxylic acid dianhydride and butane tetracarboxylic acid dianhydride.

25. The ink-jet ink according to claim 1 further containing an epoxy resin (D).

26. The ink-jet ink according to claim 25, wherein epoxy resin (D) is one or more resins selected from the group of compounds represented by the following formulas (5) to (8): 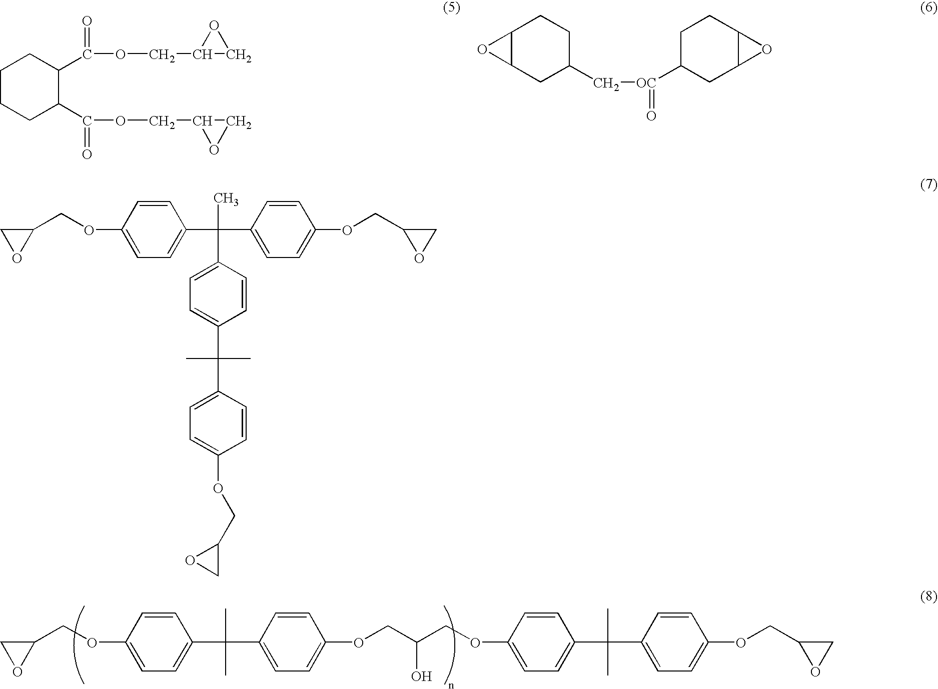
wherein, n represents an integer of 0 to 10.

27. The ink-jet ink according to claim 1, further comprising an acid generator (E).

28. A cured film obtained through a step of forming a coated film by coating the ink-jet ink according to claim 1 by an ink-jet coating method.

29. An ink coating method comprising: a step of forming a coated film by coating the ink-jet ink according to claim 1 by an ink-jet coating method followed by drying; and a step of forming a cured film by heat-treating the coated film.

30. A cured film forming method comprising forming a cured film using the ink coating method according to claim 29.

31. An electronic circuit substrate, wherein a cured film is formed on the circuit substrate using the cured film forming method according to claim 30.

32. An electronic component having the electronic circuit substrate according to claim 31.

33. An electronic circuit board and a display element comprising the cured film of claim 28.
